(19) United States
(12) Patent Application Publication
(10) Pub. No.: US 2024/0161214 A1
(43) Pub. Date: May 16, 2024

(54) Residential Development

(71) Applicant: Alexandra Yonkov, Beachwood, OH (US)

(72) Inventor: Alexandra Yonkov, Beachwood, OH (US)

(21) Appl. No.: 18/055,532

(22) Filed: Nov. 15, 2022

(51) Int. Cl. G06Q 50/16

(52) U.S. Cl. CPC G06Q 50/165

(57) ABSTRACT

A residential development comprising: at least one residence, each residence includes a living space, a bedroom and a mind-body space; the mind-body space being configured for the practice of a wellness activity; and the mind-body space being separated from the bedroom.

### TECHNICAL FIELD

In general, the following disclosure relates to a residential development having at least one residence with a mind-body space configured for practice of a wellness activity. More particularly, the disclosure relates to a residence having a mind-body space, a living space and a bedroom, where the mind-body space is separated from the bedroom.

### SUMMARY

The present disclosure generally relates to a residential development comprising: at least one residence, each residence includes a living space, a bedroom and a mind-body space; the mind-body space being configured for the practice of a wellness activity; and the mind-body space being separated from the bedroom.

The present disclosure further relates to a residential development comprising: plural residences; each residence includes multiple levels, wherein a living space, a creative space and a mind-body space are located on one level and at least one bedroom is located on another level vertically separating the mind-body space and the creative space from the at least one bedroom, wherein the mind-body space and the creative space are laterally displaced relative to the at least one bedroom.

The present disclosure further relates to a residential development comprising: plural residences connected to a shared space; each residence includes a first level and a second level above the first level; a mind-body space and a bedroom; the mind-body space being configured for the practice of a wellness activity; wherein the mind-body space is located on the first level and the bedroom is located on the second level; wherein the mind-body space and bedroom are not in vertical alignment relative to each other reducing the likelihood of acoustic transmission from the mind-body space into the bedroom; the shared space including at least one of a co-working space and a community garden.

### DESCRIPTION OF THE DRAWINGS

FIG. 1 is a front view of a residential development according to an example.

FIG. 2 is a floor plan of a first level of a residence within a residential development according to an example.

FIG. 3 is a floor plan of a second level of a residence within a residential development according to an example.

FIG. 4 is a floor plan of a third level of a residence within a residential development according to an example.

FIG. 5 is a floor plan of a first level of a shared space within a residential development according to an example.

FIG. 6 is a floor plan of a second level of a shared space within a residential development according to an example.

FIG. 7 is a floor plan of a roof top deck of a shared space within a residential development according to an example.

FIG. 8 is a perspective view of a residence according to an example.

FIG. 9 is another perspective view of a residence according to an example.

FIG. 10A is a perspective view of a creative space according to an example.

FIG. 10B is a perspective view of a creative space according to another example configured as a children's play space.

FIG. 11 is a perspective view of a co-working space according to an example.

FIG. 12A is a perspective view of a mind-body space according to an example.

FIG. 12B is a front view of a wall unit for a mind-body space according to an example.

FIG. 12C is a top view of a wall unit for a mind-body space according to an example.

FIG. 12D is a bottom view of a wall unit for a mind-body space according to an example.

FIG. 12E is a left view of a wall unit for a mind-body space according to an example.

FIG. 12F is a right view of a wall unit for a mind-body space according to an example.

FIG. 13A is a side view of a residential development according to an example.

FIG. 13B is a rear view of a residential development according to an example.

FIG. 14A is a front view of a living wall in a residence according to an example.

FIG. 14B is a top view of a living wall in a residence according to an example.

FIG. 15A is a plan view of an alternate residence according to an example.

FIG. 15B is a plan view of another alternate residence according to an example.

FIG. 16A is a plan view showing a layout of a development according to an example.

FIG. 16B is a plan view showing a layout of a development according to another example.

FIG. 16C is a plan view showing a layout of a development according to still another example.

FIG. 17 is a floor plan of a first level a residential development having plural residences and a shared space according to an example.

FIG. 18 is a floor plan of a second level a residential development having plural residences and a shared space according to an example.

FIG. 19 is a floor plan of a third level a residential development having plural residences and a shared space according to an example.

FIG. 20 is an alternate floor plan of a first level of a residence according to an example.

FIG. 21 is an alternate front view of a development according to an example.

FIG. 22 is an alternate floor plan of a second level of a residence according to an example.

FIG. 23 is an alternate rear view of a development according to an example.

FIG. 24 is an alternate floor plan of a first level of a shared space according to an example.

In the accompanying drawings which are incorporated in and constitute a part of the specification, embodiments of the invention are illustrated, which, together with a general description of the invention given above, and the detailed description given below, serve to example the principles of the invention.

### DETAILED DESCRIPTION

Commercial real estate development has largely focused on efficiencies in construction and materials with little or no focus on the well-being of occupants. A heightened awareness of the effect of the built environment on mental health, physical health and overall well-being has culminated in the development of the Well Building Standard. This standard, like the Green Building standard, sets aspirational and practical standards for improving the built environment in ways that impact personal well-being. Initially designed for commercial spaces, the well-building standard has recently grown to include multi-family and single family residences. The development of the standard highlights a long-standing yet unrealized need for real estate development that addresses this problem. The following examples are directed toward a residential development that is designed to support individual well-being and function. It is believed that this design will improve quality of life and overall well-being for its residents. The examples include a residential development, generally indicated by the number 10, that may include one or more residence 20 that includes a dedicated mind-body space 100 described more completely below. The residences 20 shown are intended for family occupants as opposed to small apartments, studios or single bedroom residences.

The impact of the pandemic also highlighted the need for residential spaces for families with ready access to a work environment separate from a living space. Long before the pandemic, residents had a need for such a space but there was no ready-made solution. Instead, residential occupants would convert a living space to create a home office or use a dedicated home office within the space. Both solutions did not address the major drawback that such spaces were still within or connected to living areas within the residence and subject to noise and distractions common during daily life with other occupants including but not limited to roommates, children and pets. Therefore, there is a need for a working space that is separate from the residential living space yet located within the residential development for purposes of ready access. Further examples include a shared work environment accessible from the residence and additional features that augment well-being.

Not solely related to the pandemic but certainly emphasized by the need to work from home during this time frame, the need for a residential space that supports well-being and is thoughtful in terms of providing spaces that allow for wellness practice is apparent. It is axiomatic that maintaining physical health through exercise practices positively impacts physical and mental well-being. Present residential built environments largely focus on the number of bedrooms without any thought to a dedicated mind-body space. The bedroom-centric mindset of present designs assumes that an occupant may convert a bedroom space for other needs and ignores the practical considerations of creating a purposeful mind-body space within a residence.

In addition, residential spaces are not currently configured to facilitate adoption of the Well Building Standards that currently are evolving for residential designs. For example, the Well Building Institute has issued its Well Building Standard™ version 2 that encompasses residential developments (Well v2™), which is incorporated herein by reference. Well v2 provides certain preconditions that must be met to obtain Well-Built certification. The Standard also provides certain optimizations that can meet a precondition or exceed the mandatory requirements for purposes of certification.

For example, Well v2 identifies preconditions relating to air, water, nourishment, movement, thermal comfort, sound, materials, mind, and community. With respect to air, the standard provides for selection of systems that meet thresholds for particulate matter, organic/inorganic gases, and radon to ensure contaminants and VOCs are monitored in regularly occupied, non-leased spaces at intervals no longer than once per year. Well provides a digital platform through which the results are reported. The standard further identifies newly installed ventilation systems designed to meet supply and exhaust rates identified in the standard for 90% of the project area as a precondition for certification. For naturally ventilated spaces without mechanical ventilation, vents and windows should be used to meet ventilation requirements with the ability to open and close during periods of occupancy. Additional preconditions listed in Well v2 relate to eliminating smoking from indoor and outdoor spaces within a project boundary and taking steps to prevent dust intrusion and/or clear the space of dust, chemical vapors and other debris to avoid aggravation of indoor air quality during construction.

With respect to water, the standard indicates that water filtration can reduce turbidity and depending on the type of device, may also trap bacteria and other contaminants. If water has low turbidity, disinfection at the point of use may be achieved with UV light. Maintaining suitable water quality includes systems that capture contaminants, such as, activate carbon filters, exchange resins and reverse osmosis systems. PH monitoring may inform the potential for uptake of corrosion byproducts and/or bacterial growth. Basic management for water quality ensures that the water sourcing, treatment and delivery operates to the levels identified in Well v2.

Turbidity, residual chlorine and pH monitoring help control basic chemical and microbiological water characteristics and, if trends are detected, may inform actions that may be needed to protect the quality of the water, such as changing a filter, check the building's pipes for leaks or inquire with the city for major works in the area. Management for minimizing Legionella requires a thorough and quantitative risk assessment of buildings' water assets, identifying locations where control is required, and a well-documented maintenance and operations program. Implementing a proper Legionella management plan should reduce the risk of exposure to pathogenic bacteria. Assets commonly vulnerable to Legionella infestation include domestic potable and hot water systems, cooling towers, humidifiers, misters, decorative fountains, spas and hot tubs to the extent that they are incorporated in a development described herein.

With respect to nourishment, Well v2 identifies preconditions relating to nutritional transparency when food and beverages are sold on site. While this may not be a feature of every development, to the extent that common areas or work spaces include such an amenity, the examples described herein provide locations in which informational materials required under Well v2 may be provided. The standard also identifies promotion of fruits and vegetables within the space if food is sold. According to examples herein, such promotion is facilitated by the provision of spaces that can be used to cultivate fruits and vegetables including but not limited to a community garden space as described herein.

For light, the standard seeks to promote light exposure and reduce circadian phase disruption. These measures improve sleep quality and impact mood and productivity. The precondition identifies providing indoor access to adequate light that aligns with circadian rhythms, i.e., the natural day-night cycle. The examples described more completely below facilitate meeting this precondition by providing opportunities for natural light to enter residential spaces and common areas, and the option to include circadian lighting systems that align with a day-night cycle.

The movement precondition promotes physical activity in everyday life and looks for project design that promotes movement through infrastructure and green spaces. The examples below facilitate meeting this standard with the provision of walkways between residential and shared spaces, shared fitness spaces, and stairs within shared spaces. In addition, the provision of dedicated mind-body and other spaces that facilitate movement within the residence facilitate meeting this precondition. Well v2 also identifies ergonomic work environments that may be applicable to shared workspace areas within the development including height adjustable furniture and work surfaces. It is understood that the furniture and work surfaces identified within the examples below may be selected to provide height adjustability to facilitate meeting the precondition identified in the standard.

The thermal comfort concept within the standard promotes productivity with a focus on HVAC systems used within a development. The standard explains that overly warm or cold environments may affect comfort, mood, fatigue, posture, muscular-skeletal issues, and in some cases heart and respiratory issues. Selecting an appropriate HVAC system will likely be specific to the particular site and is achievable within the examples described below. Optimization of the HVAC system beyond the precondition is also described in the examples herein by providing separate thermal zones that may be individually controlled for greater flexibility and thermal comfort depending on the activity within a zone and individual preferences as discussed herein.

The sound precondition seeks to identify sources of noise within a development that might negatively impact interior spaces, and identify loud areas, quiet areas, mixed areas, and circulation areas within a space. HVAC systems are identified within the standard as a source of noise and vibration. It is understood that identification of the various areas as part of the project plan will be site specific and is achievable within the context of the examples described herein. The examples are believed to optimize beyond the stated precondition by careful attention to the acoustic impact of activities within the space and unique relationship of spaces to minimize such impact. Moreover, with respect to HVAC systems, examples herein provide for location of this equipment remote from living spaces minimizing any potential impact from this system.

From a material standpoint, the Well v2 precondition identifies selection of construction materials that contain less than 1000 ppm of asbestos, 100 ppm of lead, 1000 ppm of mercury by weight and 100 ppm of carbonates and sulfates. It also identifies evaluation of building materials to avoid excessive PCBs and CCA, and selecting lighting that avoids use of compact fluorescent bulbs. These types of material selections may all be achieved within the subject development in accordance with the precondition.

Promotion of mental health or mind within the standard focuses on programming including education, policies, and communications to residents relating to mindfulness and wellness. These activities, which would be put on by the developer, residents, home owner's association or third party may be achieved within the examples described herein. The development in the examples further facilitates such programming by providing shared spaces that are suited for programming to residents, such as group meeting space and community garden and outdoor patio areas. The precondition also identifies dedicated spaces for restoration and relaxation, and integration of nature throughout the project. As discussed more completely below, the example residences and development provide multiple areas for relaxation and restoration to facilitate meeting this precondition and also provide indoor and outdoor areas where nature is integrated.

The Well community precondition focuses on communication and requires a Well feature guide for residents highlighting the Well features within the project; an emergency preparedness plan; and occupant survey to collect feedback from occupants. In addition, the preconditions focus on stakeholder planning and orientation communications to promote occupant health and facilitate other communication preconditions within the standard. These communications would likely be site specific and are not related to the development examples described herein. As noted, the examples facilitate meeting the standard from a structural and design plan standpoint which also will facilitate the types of communications contemplated under the community precondition. As discussed above, providing community spaces and shared spaces that allow for and promote the types of communication within the precondition go beyond the basic precondition and are believe to optimize the examples for this aspect of the standard.

As identified in connection with the above preconditions, Well Certification is a performance-based standard measured in the context of a completed residential development. The examples provided herein are configured to facilitate meeting the preconditions for purposes of obtaining certification. It is understood that the choice to obtain certification may be influenced by practical features including but not limited to the site, availability of certain systems and materials, project costs and other factors. While the examples described herein are configured to facilitate Well Certification of the development, such certification is optional for purposes of building a residential development according to the invention.

According to the examples, a mind-body space, generally indicated by the number 100 is provided within a residential development 10 having at least one residence 20. As described in the examples below, the mind-body space 100 may be incorporated within each residence 20. A shared space 300 within the residential development 10 may be provided as described in later examples. The mind-body space 100 may also be incorporated wholly or partially within the shared space 300 as described below.

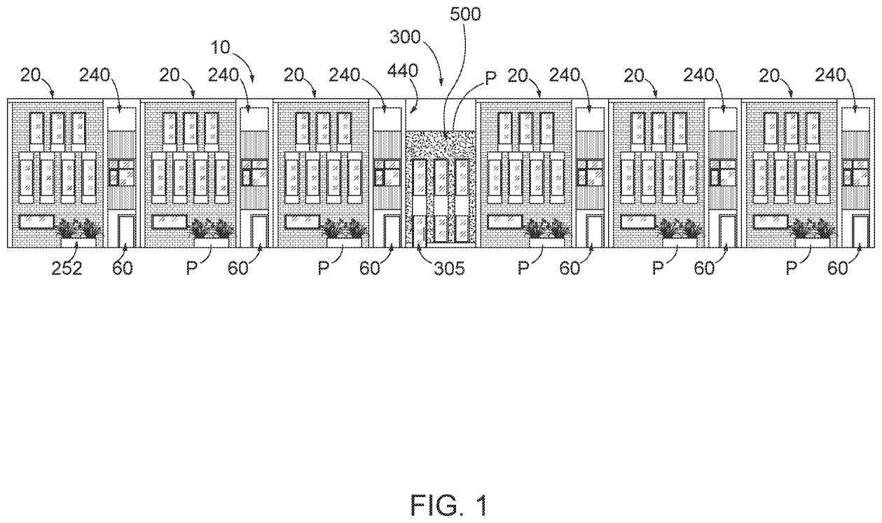

With reference to FIGS. 1-4, residential development 10 may be configured to have at least one residence 20. FIG. 1 shows six residences 20, but other configurations of one or more residence(s) may be provided. As shown, each residence 20 may be configured as a townhome or condominium type of structure. This example is not limiting as the residential development 10 may be configured as a standalone structure or incorporated in other types of developments including but not limited to high-rise structures, cluster homes, other residential complexes. As described more completely below, aspects of the development 10 and residences 20 therein are designed to support overall well-being. For example, each residence 20 may include features that facilitate well-being including but not limited to locating living spaces, as opposed to bedrooms, to allow flexibility of use early in the morning or late evening hours without disturbing the rest of the family; integrated audio technology; separate heating ventilation and air conditioning (HVAC) zones; separate thermostats or home automation controls. Additional features may include circadian lighting; interior and exterior green features, such as living walls, planters, and the like; additional insulation for purposes of thermal or sound control; or exercise equipment including but not limited to a networked mirror; TRX equipment or equivalent; a Peloton bike or equivalent cardio equipment. The development itself may support well-being by including a shared space to encourage community interaction, gathering and programming. The shared space may include spaces that specifically support wellness including but not limited to a fitness space, a co-working space and a community garden space. Other social spaces may include meeting spaces, common areas, green spaces, rooftop patios and outdoor kitchens.

In the example, residence 20 has an outer wall that defines a perimeter 22 of the residence 20. As described below, the outer wall may be shared in a multiple residence configuration of residential development 10 or when a residence is adjacent to a shared space 300. In the example, perimeter 22 of residence 20 has a rectangular configuration with a front wall 22A, a rear wall 22B, a first sidewall 22C and a second sidewall 22D forming the perimeter 22 of each residence 20. This example is not limiting as other configurations including other regular and irregular polygons; abstract shapes; circular or oval shapes or other shapes limited only by the imagination of the designer may be used. Residence 20, in the example, has multiple levels and may include a stair case 25 connecting the levels. If needed, an elevator may be provided for this purpose.

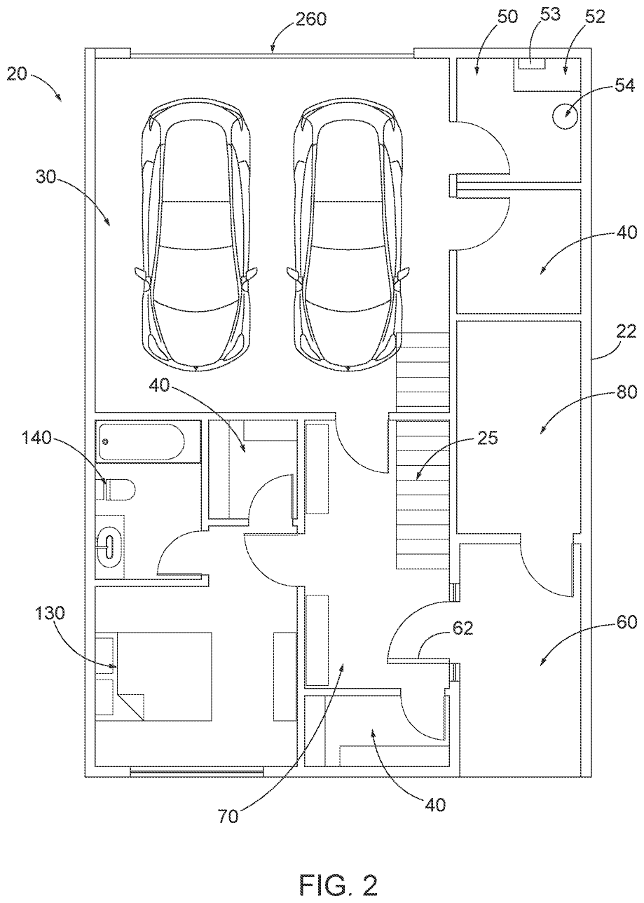

The residence 20 includes a mind-body space 100 discussed more completely below, and may include a living space 110, a kitchen 120, a dining room 125, a bedroom 130, a bathroom 140 and other spaces used in residential construction. For example, with reference to FIG. 2, a lower level may include additional storage spaces, such as a garage 30 to store vehicles 32; closet(s) or storage space(s) 40; a mechanical room 50, housing heating and cooling or HVAC equipment 52 and/or a water heater 54; an entryway 60 housing an external entry door 62; and a mudroom or entry hall 70, where occupants can remove outdoor clothing before entering a living space.

An external storage space 80 may be located near entryway 60 yet accessed from the exterior of the residence to provide convenient storage for larger pieces of sporting equipment that are typically used outside or transported for use including but not limited to watercraft, such as kayaks, canoes, stand-up paddle boards, surf boards and tubes; snow equipment, such as skis, snowboards and snow shoes; bicycles; and other similar equipment. This storage 80 supports well-being through the encouragement and facilitation of outdoor activities and sport. It is expected that developments of this type are more likely to be used in urban settings and the ability to facilitate storage and ready exterior access to this equipment while at the same time enclosing such equipment in a secure locked storage 80 is attractive to occupants. The types of spaces and the arrangement of the spaces depicted are provided as examples and are not limiting.

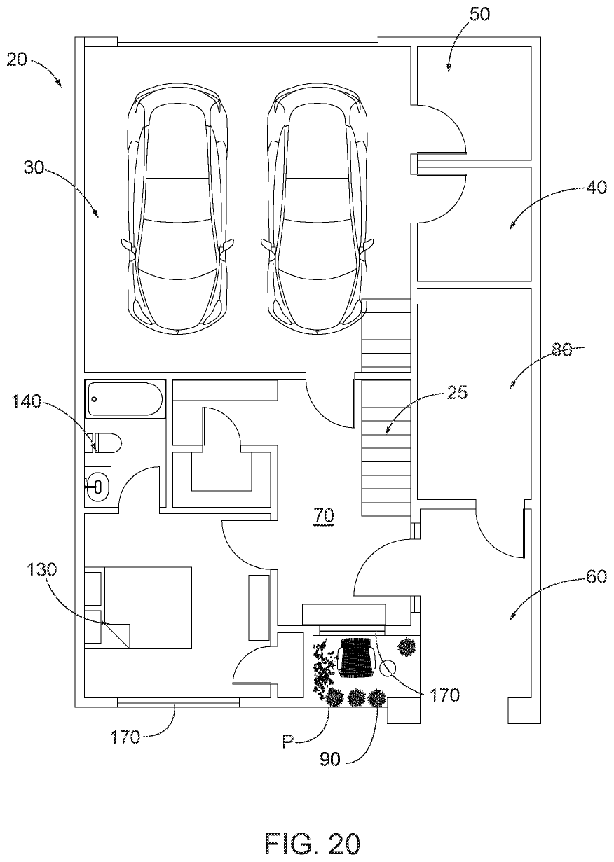

One alternative arrangement of spaces on a lower level is shown in FIG. 20. This example includes a patio area 90 adjacent to entryway 60. Patio 90 may include plants P or other natural elements to visually enhance the patio 90 and provide interaction with nature immediately upon entry into the residence. This interaction fosters wellness of occupants or visitors as discussed herein. In addition, a window 170 is located to extend the interaction within the residence 20 as described below.

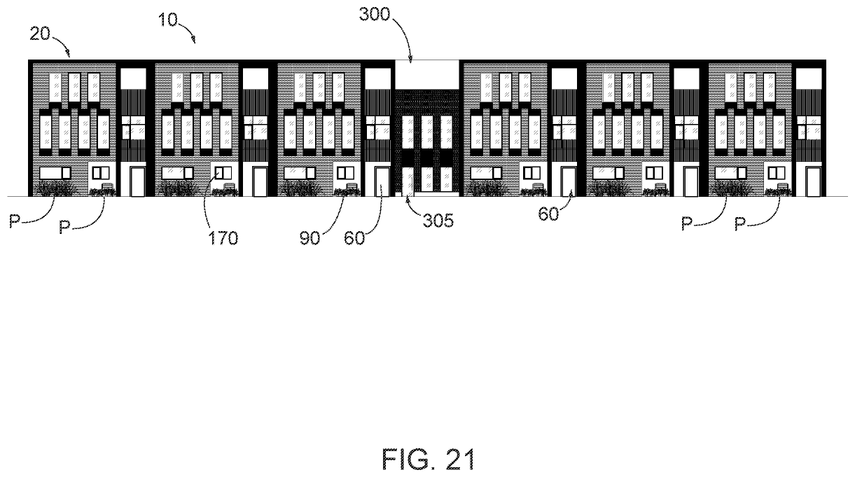

As shown, the wall adjacent to patio 90 may be provided with a window 170 to bring natural light into the entry space 70 within the residence and provide a view from within to the natural elements on or beyond the patio 90. With reference to FIG. 21, window 170 may be of a type that can be opened to provide natural ventilation to the residence 20. Additional openable windows may be provided on the lower level including the window 170 to bedroom 130 shown to the left of patio 90 in this figure.

Seating may be provided on the patio 90 and face outward to encourage interaction with neighbors and otherwise encourage and facilitate community connection from the residence 20.

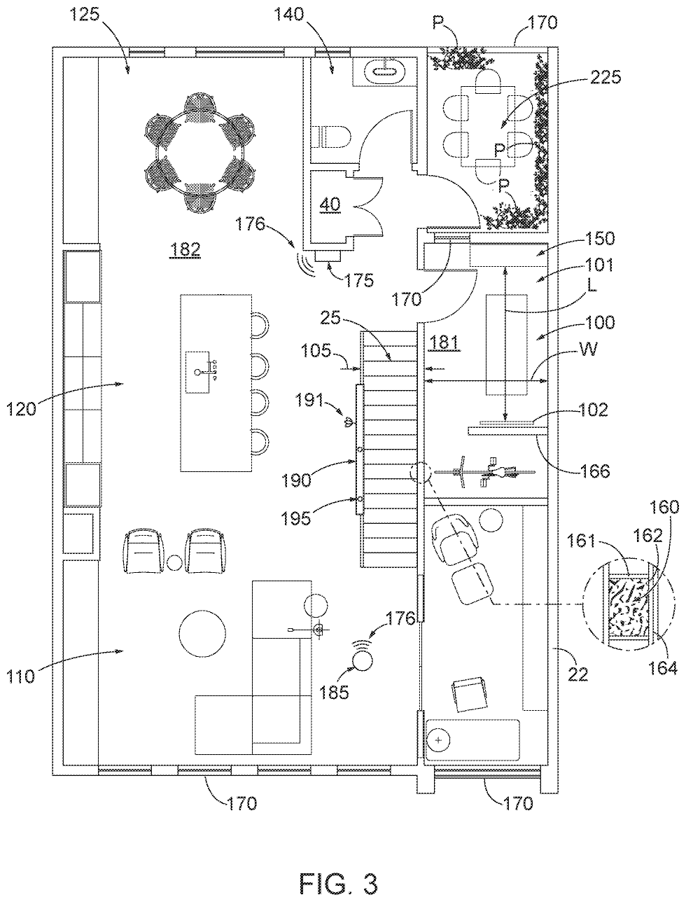

With reference to FIG. 3, as part of the goal of providing a residence that supports wellness, a mind-body space 100 is provided as part of the residence 20. The mind-body space 100 is a dedicated space for wellness practices or wellness activities. Examples of wellness activities include but are not limited to yoga, meditation, online subscription fitness classes, and the like. These examples are not limiting. Wellness activities provide rest and restorative benefits for the occupant performing such activities. As discussed more completely below, mind-body space 100 may be configured to facilitate these wellness activities and provide the environment needed for practicing wellness activities at any time while minimizing the disturbance to other family members or spending extra time for preparation. In the example, mind-body space 100 is located on a second level. This placement is not limiting, as the mind-body space 100 can be located on other levels as well.

To configure the mind-body space 100 for wellness activities, mind-body space 100 may include an open space or practice area 101 for a wellness activity. For example, when yoga is the wellness activity, practice area 101 may have a length L long enough to allow a user to lie on a yoga mat and a width W sufficient to accommodate a person with the arms outspread or legs to one side as is common in yoga poses. It will be understood that such a space will be suitable for many other wellness activities listed above. To accommodate subscription wellness activities, a fitness mirror 102 that is connected to the internet, via a wired or wireless connection 176 described below, may be provided. By providing a dedicated space for such activities, mind-body space 100 may be set up by the user for their intended practice and left in that state so that, when they are ready to practice, they simply enter the room and begin with minimal, if any, preparation of the mind-body space 100. This is distinguished from current practices that seek to convert existing living spaces for wellness activities by dragging out equipment and then having to store it again after use.

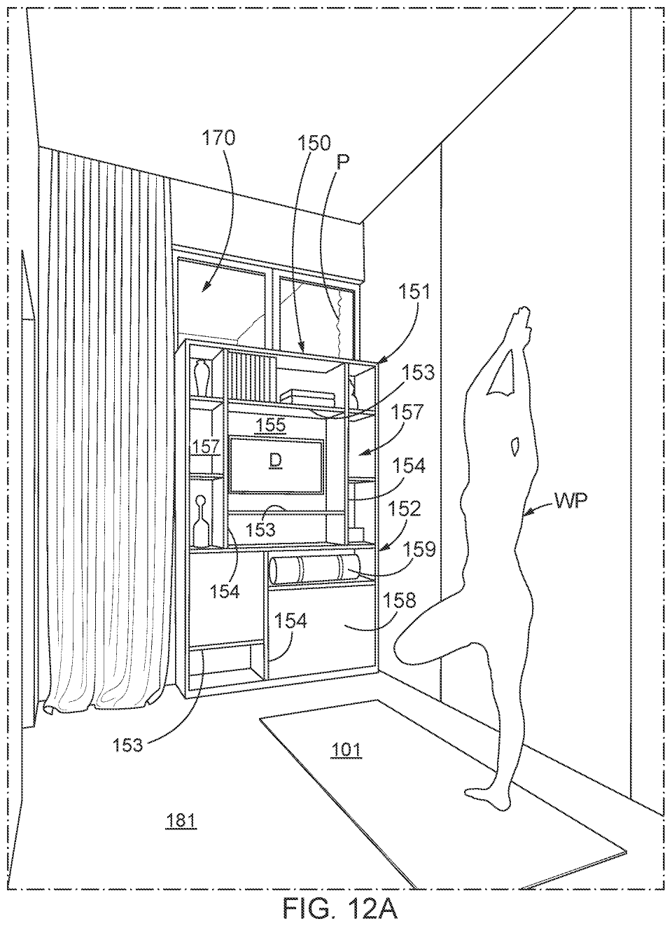

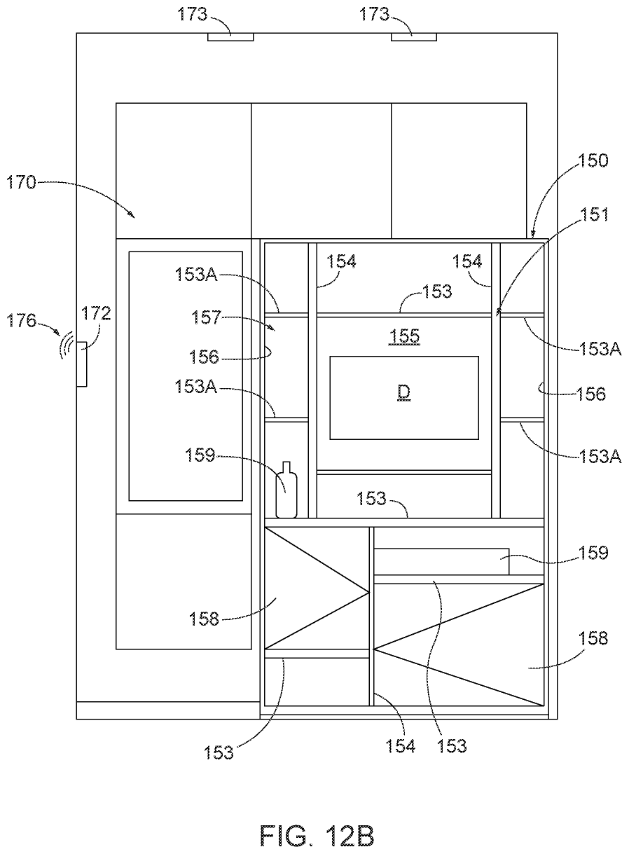

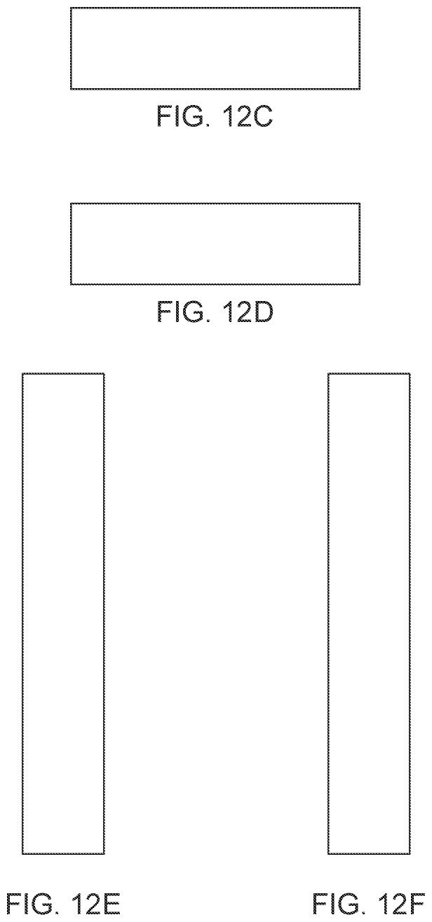

To further configure the mind-body space 100 for wellness activities, a wall unit 150 may be provided to conveniently display and store wellness accessories. Again, this may help minimize preparation before wellness practices by having equipment or objects used in such practices immediately at hand. Wall unit 150 may simply include a platform that may be used to create a puja table or other area dedicated to meditation and similar spiritual practices. In the example shown in FIGS. 12A and 12B, wall unit 150 includes a first storage unit 151 and a second storage unit 152 separated by a horizontal divider or shelf 153.

The first storage unit 151 includes a pair of vertical dividers 154 that are spaced from each other to form a central area 155 and also spaced from each of the sidewalls 156 of the wall unit 150 to form side areas 157. The central area 155 and side areas 157 may be further divided in a vertical sense by horizontal dividers or shelves 153 as shown. In the example, central space is divided into three vertical spaces by two horizontal shelves 153. The central area 155 between the two shelves is larger and may house a television, lap top, or other audio/visual device D to facilitate wellness practices WP that require such a device D. Similarly, the side areas 157 may be divided into three vertical spaces by two horizontal shelves 153A to facilitate storage or display of wellness accessories 159 in the side areas 157 including but not limited to statues, focus devices for meditation, essential oils, diffusers, incense, books, flowers or other plant materials, and water.

The second storage unit 152 may include similar open areas for displaying wellness accessories or as shown include closed portions to store articles out of site. In the example, second storage unit 152 includes a vertical divider that may be used to support horizontal shelves 153 and divide the space vertically. In the example, a single horizontal divider is supported on either side of the vertical divider 154. A door 158 covers the space created above the horizontal shelf 153 on one side and a second door covers the space created below the horizontal shelf on the other side. An open area is created below the horizontal shelf below first door and above the horizontal shelf and second door on the other side. The open areas may be used to store objects that need to be readily accessible during wellness activities such as a yoga mat, weights, towels, resistance bands, water and the like. Mind-body space 100 may further include a nook secondary space formed behind a divider 166 to facilitate storing larger objects and opening the practice area 101.

This nook may also provide a separate space for a wellness activity. In the example, a stationary bike, like a Peloton bike may be the primary wellness activity. This activity may occur within practice area 101. Or, as shown, divider 166 may create a space within mind-body space 100 for use of a stationary bike or similar piece of equipment. For example, stationary bike may be located behind divider 166, as shown. This configuration increases the flexibility of the mind-body space by allowing two dedicated activities to coexist in the mind-body space 100.

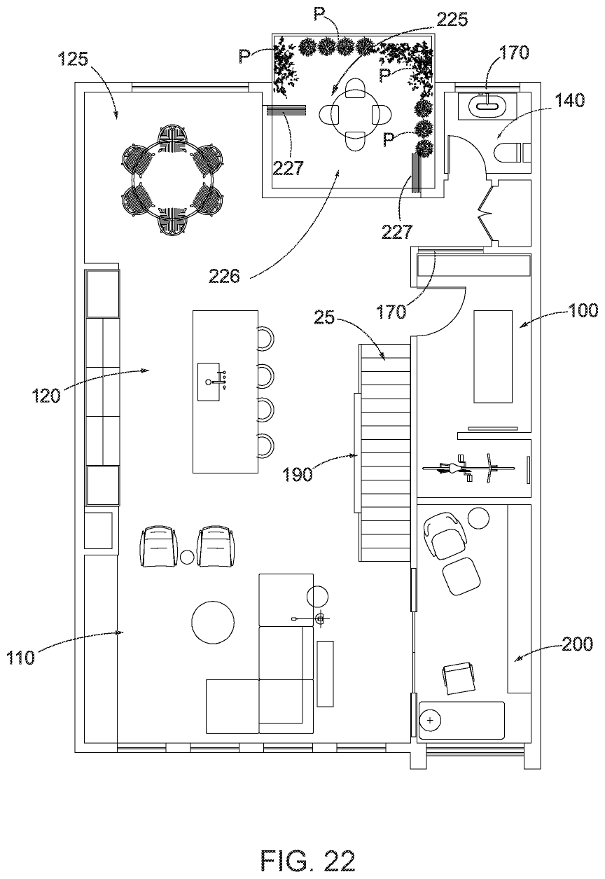

With reference to FIG. 22, an alternative configuration is shown where the space behind divider 166 includes a screen or fitness mirror dedicated for the stationary bicycle of other piece of fitness equipment within the nook. In this example, the bicycle or other fitness equipment faces the screen to facilitate its use during the activity.

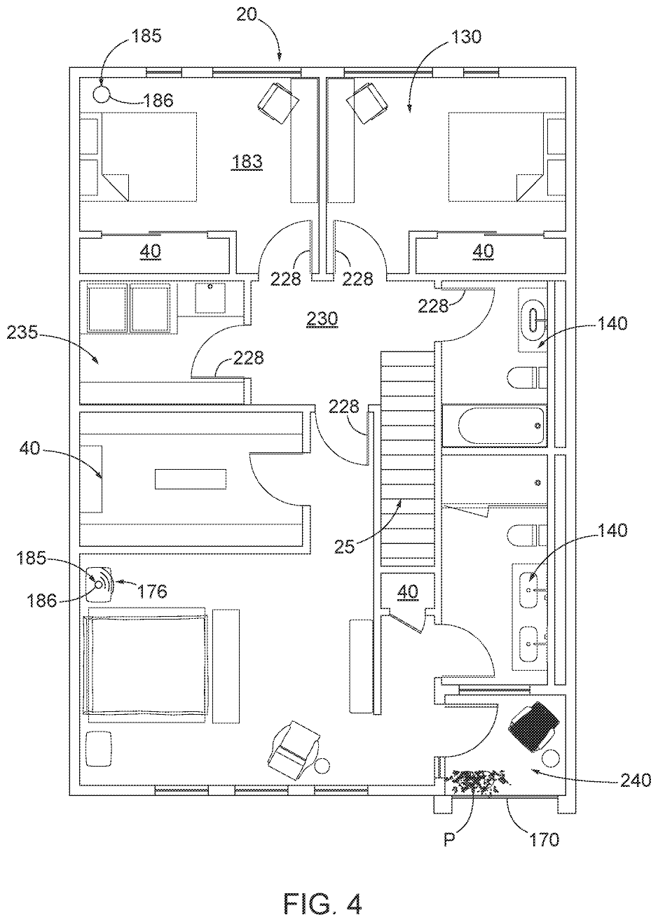

Given that wellness practices may involve noise from instruction or the activities being performed, the mind-body space 100 is located within the residence 20 such that it is separated from other spaces as described more below. Given that noise may prevent one from falling asleep or disturb a sleeping occupant, the mind-body space 100 is located away, i.e., separated from the bedrooms 130. With reference to FIGS. 3 and 4, the mind-body space 100 may be vertically separated from the bedrooms 130 by placing mind-body space 100 on a different floor than the bedrooms 130. In the example, the mind-body space 100 is placed near to the living space 110 on second level (FIG. 3). The mind-body space 100 is distanced from the bedroom(s) 130 located on a third level (FIG. 4). Placing the mind-body space 100 on a separate level from bedrooms 130 provides separation, but it will be understood that separation may also be achieved with the mind-body space on the same level as the bedrooms. The mind-body space 100 may be further separated from a bedroom by laterally displacing it relative to the bedroom between levels. In other words, the footprint of the mind-body space does not overlap the footprint of bedroom 130 between the two levels.

With continued reference to FIGS. 3 and 4, mind-body space 100 may also be placed near the perimeter 22 of the residence 20 to help distance it from other spaces. In the example, outer wall 22 of residence 20 forms the outer wall of mind-body space 100. The outer wall 22 may be configured with a rectangular perimeter having a front wall, rear wall, first side wall and a second sidewall. In the example, mind-body space 100 is located adjacent to first side wall spacing it from the bedrooms, which are located along front wall, second side wall, and rear wall. This location also separates mind-body space 100 from living space 110. Placement of the stairs 25 adjacent to an inner wall of mind-body space 100 further separates this space from other spaces. The air gap 105 created by locating the stairs 25 adjacent to mind-body space 100 helps insulate this space in terms of noise and vibration transmitted to other spaces. In the example, mind-body space 100 is separated from living space 110 and kitchen space 120 by stairs 25. As described more completely below, insulated walls surrounding mind-body space 100 may provide further sound and thermal insulation useful in preventing activities from disturbing other occupants and to control the temperature within mind-body space 100.

Placing the mind-body space 100 away from bedroom(s) 130 contemplates the importance of rest and sleep on overall wellness and minimizes the impact on occupants that may be trying to rest or sleep within bedroom(s) 130. This placement also facilitates wellness practices by expanding the time-frame in which the mind-body space 100 can be used without impacting the rest of others within the residence 20. It will be understood that children often may need to sleep at earlier hours than adults in a residence 20. Or adults that work later shifts may sleep later. Similarly, some residents may wish to sleep later into the morning. Separating the mind-body space 100 from the bedroom 130 provides greater flexibility to perform well practices that may create noise, vibrations, or otherwise disturb sleep. In the multi-level example shown, to further separate the mind-body space 100 from bedroom(s) 130, a non-bedroom space may be located above the mind-body space 100. For example, considering FIGS. 3 and 4, a bathroom 140 is located above mind-body space 100 on third level. As on the level where the mind-body space 100 is located, the stairs 25 on third level may separate the bathroom 140 from bedroom 130 to further reduce the likelihood of sound from mind-body space 100 reaching bedrooms 130.

To further attenuate any noise or vibration emanating from the mind-body space 100, mind-body space 100 may be constructed with an increased insulation value relative to the remainder of the residence 20. To that end, insulation 160 may be applied to or around mind-body space 100 to increase the insulation value. For example, if internal walls forming the living spaces are created with stud walls 161 that define air gaps 162 without additional insulation, the walls surrounding mind-body space 100 may include insulation 160 within the gaps 162. In another example, insulation may be increased by using a thicker drywall 164 in or around mind-body space 100. As a further alternative, sound absorbing panels or insulating objects 166 may be provided within or around the mind-body space 100 to improve noise/vibration dampening.

Certain wellness practices including but not limited to yoga may be facilitated with separate temperature control of the mind-body space 100. The increased insulation also may assist in regulating temperature within the mind-body space 100. To provide natural ventilation and light, mind-body space may have a window 170. Window 170 may be on an outside wall allowing light and air from outside to enter, or as shown, window may simply open to a space, which in turn has its own window to allow light to pass into mind-body space 100. The amount of light entering the space may be controlled by the occupant through curtains or blinds as shown in FIG. 12A. The window 170 can be provided with panels or panes that open to allow for natural ventilation within mind-body space 100. Alternatively, mind-body space 100 may be provided as a separate heating/cooling zone within the residence 20 to control temperature and circulate air in this space separate from other zones within the residence 20. For example, mind-body space 100 may have a separate temperature sensor or thermostat 172 to control the heating and cooling equipment 52 (FIG. 2). The temperature sensor 172 in mind-body space 100 may be connected to a central temperature controller or home automation system 175 that controls the temperature in multiple zones throughout the residence 20.

It will be appreciated that physical exertion within the mind-body space 100 may make it desirable to maintain a lower temperature relative to an adjacent living space. Alternatively, a higher temperature may be desired to facilitate clothing choices for mind-body space 100 activities, or certain temperature may be needed for certain well practices. As an example, hot yoga is a common well practice that demands significantly higher temperatures than normal residence temperatures. The heating and cooling system 52 may be any number of systems commonly used in a residence to provide suitable heating and cooling for wellness practices. In the example, a forced air heating and cooling system 52 is used with one or more air vents 173 within mind-body space 100.

Relatedly, overall residence wellness is facilitated by temperature control, adequate ventilation and other HVAC considerations. To facilitate these practices or meet Well-building standards, a home automation system 175 may be used to automate operation of the heating and cooling system 52 and other appliances to promote wellness and meet or exceed wellness standards including but not limited to the Well Building standard. The home automation system 175 may be connected to various components within the residence as discussed herein. The connection 176 may be wired or wireless, such as via a Mesh network, CAT 6 or similar wiring, low voltage wired systems or wireless technologies including but not limited to Bluetooth protocol, Wi-Fi protocol, or cellular systems. Connection 176 may include any equipment needed to provide a wireless connection including a modem, wireless router and the like. With respect to HVAC equipment, the heater, air conditioner, valve or flaps within the ventilation system may be in communication with home automation system 175 via connection 176 so that home automation system 175 may control their operation. Home automation system 175 may define separate zones within residence 20 for purposes of controlling at least one of temperature, lighting or sound separately within each zone as discussed with reference to the mind-body space 100 above. In the example, the mind-body space 100 is a first zone 181 and living space 110 is a second zone 182 on the same level. Bedroom(s) 130 or, in the example third level, may be included as a third zone 183 to allow different temperatures within the bedrooms 130 for sleeping than those in the living space 110. Any number of zones may be created with a suitable heating and cooling system 52.

With attention to the overall wellness within residence 20, the heating ventilation and air conditioning equipment 52 may be selected to meet or exceed Well-building standard preconditions for residences including features such as a suitable filtration system 53 and suitable ventilation for ensuring room-air changes within the range established by the Well-building Institute. For example, filtration may include annual average outdoor particulate matter thresholds of 23 micrograms per cubic meter or less with a minimum air filtration level of greater than or equal to 80%; 24-39 micrograms per cubic meter with a minimum air filtration level of greater than or equal to 90%; or 40 micrograms per cubic meter or greater with a minimum air filtration level of greater than or equal to 95%. Suitable filters include MERV 12 or M6; MERV 14 or F8; or MERV 16 or E10 respectively. With respect to interior pollutants from cooking, cleaning and other activities, ventilation rates within the residence 20 may be designed in accordance with ASHRAE 62.2-2013 ventilation rate procedure for dwellings or ASHRAE 62.1-2013 for shared areas. If needed, additional ventilation devices beyond the ventilation provided by the forced air heating and cooling system 52 may be provided including but not limited to a down-draft system or hood in the kitchen 120. Relatedly, natural ventilation is a wellness consideration and the residence 20 may have windows or doors that have at least a portion that may be opened to allow the ingress of outdoor air.

Lighting is another wellness consideration. Natural lighting is provided through windows and glass doors throughout the residence. Interior spaces may have Light fixtures within the residence are provided to provide adequate lighting. This lighting may also be adjustable in terms of its brightness to maintain the correct amount of lighting for a particular activity and to avoid an overly stimulating environment, which can cause fatigue and/or anxiety. As a further optional feature, lighting may be circadian lighting generally indicated at 185 to facilitate occupant circadian rhythms. The circadian lighting 185 may include lights 186 that are connected to a home automation system 175 via a connection 176, such as a Wi-Fi system. Circadian lighting 185 is designed to have a biological impact on the human circadian system signaling the brain when it is daytime and when it is night. A healthy circadian rhythm is associated with long term health and promotes better sleep. Circadian lighting 185 may illuminate lights 186 at a given time of day to signal that it is daylight and help rouse sleeping occupants. To that end, circadian lighting 185 may be located in bedrooms 130 (FIG. 4). Circadian lighting 185 may be provided in other parts of the residence 20 including, for example, living space 110 (FIG. 3) as shown. The amount of light produced by lights 186 may be increased gradually to simulate a rising sun. Circadian lighting 185 may also dim lights 186 to darkness at night to signal that it is time to sleep. Circadian lighting 185 may simply control white light intensity or use color tuning to produce the circadian brightening and dimming effects over the course of a day.

Similarly, home automation system may include an integrated audio system with speaker connections pre-wired throughout the house and connected to the audio system. Residents may have speakers installed in desired locations within any or all of the spaces within the residence. Home automation system may be used to control, the location and volume of any audio playback. Pre-wired speaker drops may be provided in the walls, floors or ceilings.

Scientific data shows that natural patterns help calm the mind and promote mental health. To that end, residence 20 may be configured to have an integrated biophilic zone. A biophilic zone is a location that facilitates interaction with plant material. A living wall 190 is one example of a biophilic zone. The residence 20 may incorporate a living wall 190 having live plant material growing on it. The living wall 190 may include artificial plant material 191 having natural patterns 192. While not providing the same benefits as interaction with living plants, it has been found that the visibility of natural patterns 192, from live plants or artificial sources, has a positive effect in reducing agitation or promoting a sense of calm and well-being of the occupants. A NASA study on the effects of space travel on mental health and well-being demonstrated that the absence of natural patterns led to agitation, increased stress, and a general decline in mental well-being. Viewing natural patterns, even if only an image or reproduction of such patterns, for periods during the day reduced the level of agitation and providing a mind-calming effect. This study generally supports the premise of bringing the outside into built spaces to assist in promoting the well-being of occupants that are surrounded by a built environment. As discussed herein, the residence 20 includes dedicated areas or zones for interacting with viewing and cultivating natural material in accordance with these principles. The living wall 190 is one example.

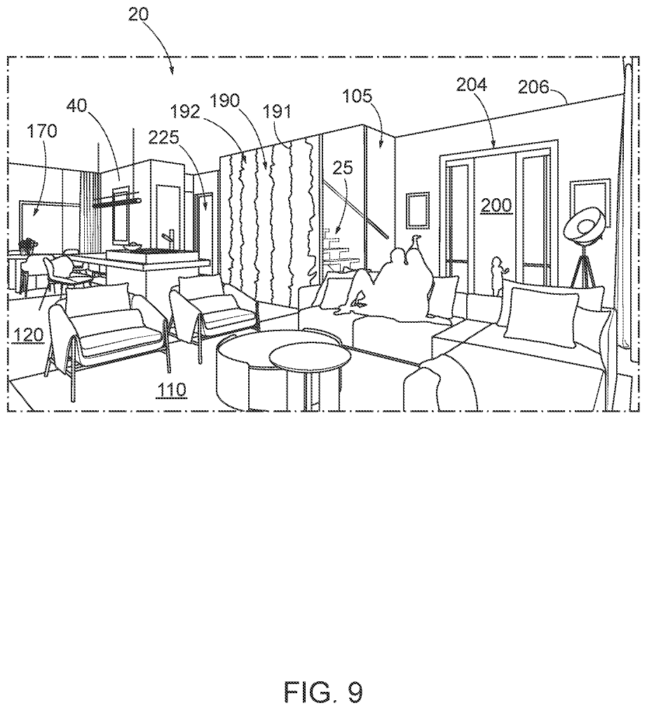

In the example, living wall 190 is located centrally in the residence 20 to promote its visibility. As best shown in FIG. 9, living wall 190 may be placed between the stairs 25 and the living space 110 and/or kitchen 120. As previously discussed, the mind-body space 100 may be located on the opposite side of stairs 25. The plant material 191 may provide further noise dampening for mind-body space 100. When real plant material 191 is used, watering of the plant material 191 may be conducted manually or through a dedicated irrigation system 195. To that end, plumbing within the wall may be provided to facilitate watering or use of the irrigation system 195.

In addition to the mind-body space 100 described above, other spaces may support overall wellness in the residence 20. For example, a creative space 200 may be located within residence 20 to provide a dedicated space for creative activities including but not limited to writing, art, crafting, reading, children's activities, play space, and music. These examples are not limiting. Such a space can be placed in any location within the residence 20 including the first level, second level or third level. Since the creative space 200 may involve activities that create noise or vibration, it too may be located such that it is distant from bedrooms 130 to minimize the disturbance to occupants wishing to sleep. In the example, creative space 200 is located on second level opening off of the living space 110. Like mind-body space 100, it is located at the periphery of the residence 20 and separated from living spaces by the air gap 105 defined by stair case.

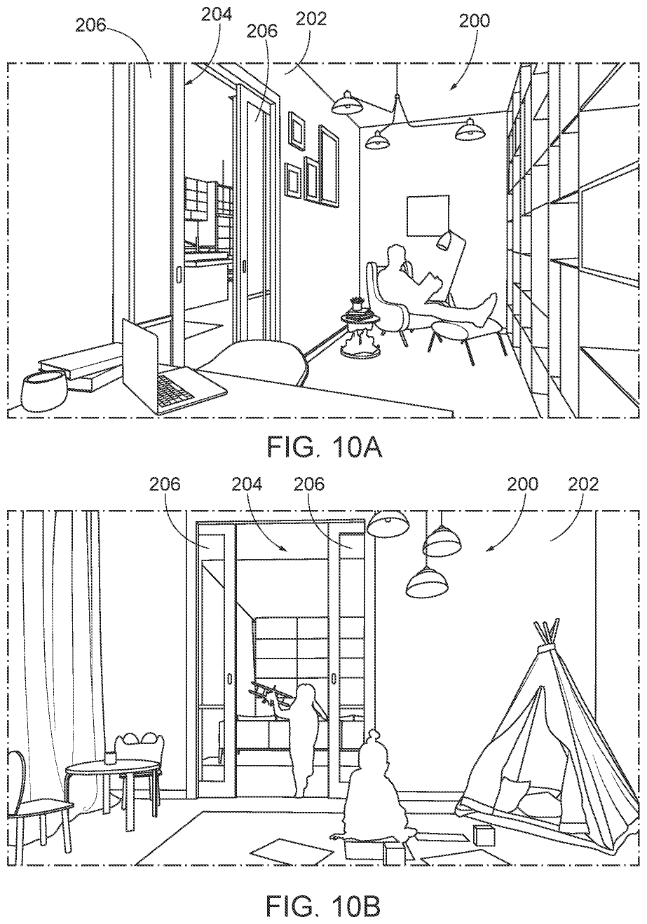

Comparing FIGS. 3 and 4, creative space 200 is located at an outer periphery beneath a terrace and a bathroom such that it is not aligned with a bedroom area. The inner wall 202 of creative space 200 is shared with the inner wall of the mind-body space 100. Creative space 200 may be provided with a double door 204 that has glass panels 206 (FIG. 10) to provide a visual connection between the creative space 200 and living space 110. This allows the person performing a creative activity within the space the ability to keep an eye on occupants in the living space or vice versa. In the example shown in FIG. 10, creative space 200 may be an area where children can play or enjoy creative activities while parents remain in the living space 110. The visual connection between these spaces allows parents to be able to monitor children while enjoying their own activity in the living space 110. In addition, a window 170 is provided in creative space to provide direct access to natural light and views of nature outdoors. In the example, a chair faces window to provide a direct line of sight to nature optimizing this space for purposes of Well certification.

Creative space 200 may be provided with any equipment, furniture, appliances or accessories required for various creative activities including but not limited to work tables, sound systems, craft and art supply storage, toy storage, chairs, stools and the like. A sink and faucet may be provided for use in various educational/crafting activities including but not limited to painting, pottery, science/school projects, plant cultivation, and the like. In the example shown in FIG. 10A, creative space 200 is configured to be used for writing, listening to music or education/crafting. A desk may be provided for writing. A lounge chair and stool may be used to write or listen to music. Shelving may be provided to store or display, books, art supplies, plant cultivation material, toys or other objects used in creative space. In the example shown in FIG. 10B, the room is generally unfurnished and designed to be a children's room capable of use for play or other creative activities suited for children. In either example, creative space 200 has an external window at one end allowing natural light to enter and providing the occupants with views of nature outside to again promote overall wellness.

An outdoor space 225, such as a deck, patio or terrace is adjacent to and aligned with mind-body space 100 at the opposite end of residence relative to creative space 200. Providing an outdoor space 225 adjacent to mind-body space 100 provides access to sunlight and outdoor air via window 170 into space 225. Plant material P may be provided within space 225 due to the abundance of natural light L. The use of this space 225 may vary depending on the needs of the occupants. It may be a dining area; a garden area or room for plants; a meditative space or other use that takes advantage of being outdoors. In the example, in addition to being located at the periphery 22 of the residence 20, this space 225 is isolated by the placement of a bathroom 140 and a closet 40 between it and the kitchen 120 and dining area 125. This placement facilitates quiet practices within the space 225 free from sounds from the kitchen/dining/living areas and on the other hand isolates any sounds from this space 225 from those areas.

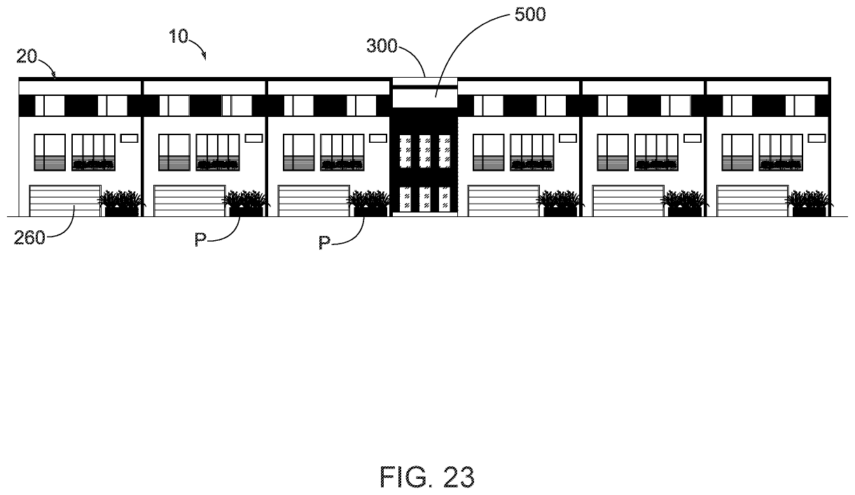

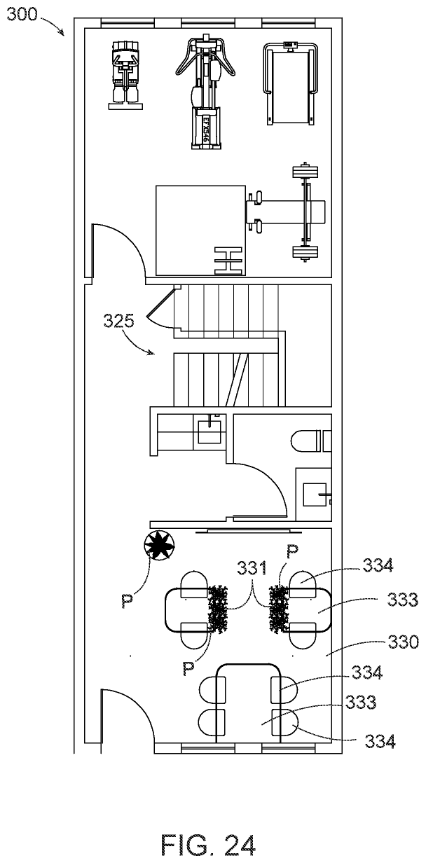

With reference to FIG. 23, an alternative configuration of the outdoor space 225 is shown. In this example, outdoor space 225 includes an outdoor terrace 226. The terrace 226 includes an outdoor portion that opens externally of the residence 20, and may include an indoor portion that extends within the perimeter of the residence 20, as shown. In the example, terrace is centrally located to bring the outdoors within multiple spaces of residence 20 as described below.

Glass doors or floor to ceiling windows may be used to visually connect terrace 226 to the living spaces forming an atrium within residence 20. In the example, folding glass doors 227 are provided to permit complete opening of the atrium to the outdoors by folding the doors back as shown. The visual connection of outdoor and indoor spaces provides an opportunity for a biophilic zone. The access to sunlight on the terrace allows cultivation of plant material on the terrace. To make this easier, terrace 226 may include dedicated plumbing and spigots. In the example shown, a portion of terrace is cantilevered beyond the perimeter of outer wall to increase its exposure to sunlight and also expose plant material to rain.

As shown, folding glass doors may extend inward from the exterior wall of residence 20 extending the terrace 226 into the living space. In doing so, natural light is brought further inside allowing cultivation and interaction with plants P inside the living space of residence 20. Notably, in the example, the glass doors extend the sunlight further into the interior of the residence including the kitchen, dining area, staircase and mind-body space receive a direct increase exposure to sunlight compared to the example shown in FIG. 3.

Relative to FIG. 3, in the configuration shown in FIG. 23, the bathroom 140 is pushed toward the outer edge of the residence 20. The end wall of mind-body space 100, which contains clerestory windows receives light and potential ventilation indirectly from patio in this example. If needed, the amount of light from patio space may be controlled by window treatments including but not limited to curtains, blinds, variable opacity glass, screens and the like.

With reference to FIG. 4, as discussed previously, bedrooms 130 are place on a separate level from the living spaces, mind-body space 100 and creative space 200. This creates separation to facilitate restful sleep. Considering the arrangement of the bedrooms 130 shown in this example, they are placed at the perimeter 22 of the residence 20 in a somewhat C-shaped configuration or inverted L configuration. The open portion of the C or L corresponds to the mind-body space 100 and creative space 200. In this way, bedrooms 130 are not located above the mind-body space 100 or creative space 200 further attenuating any noises from these two spaces. A guest bathroom 140 is located above mind-body space and a master bathroom 140 is located above a portion of creative space 140. A small terrace may be provided over the remaining portion of creative space as described more below. The bedrooms 130 each are separated by doors 228 from the stairs 25 and a landing 230 centrally located within the residence. Master bedroom 130 may be separated from the landing by a walk-in closet 40 along one side. This placement also helps separate the master bedroom from a laundry room 235 that opens off of the landing 230 and is located between the bedrooms 130 opposite the stairs 25. In the other bedrooms, closets 40 may be located along the walls facing the landing 230 or laundry 235 area to provide an air break between these spaces further insulating the bedrooms from the noise that might be present in these spaces.

As indicated above, a terrace 240 may be provided off the master bedroom 130. Terrace 240 may have its own door 228 to allow for isolation of the terrace 240 from bedroom 130. Such space may be useful for meditation, reflection, reading, or simply a quiet moment outdoors. As discussed above, these features are helpful in supporting overall wellbeing and reducing stress, anxiety or agitation. With that in mind, development 10 may include green spaces, generally indicated at 250, visible from residence 10 as schematically shown in FIGS. 1,13B, and 16A-16C. Likewise, terrace 240 itself may have a planter or individual plants P on it, as shown, creating another biophilic zone available to the occupants.

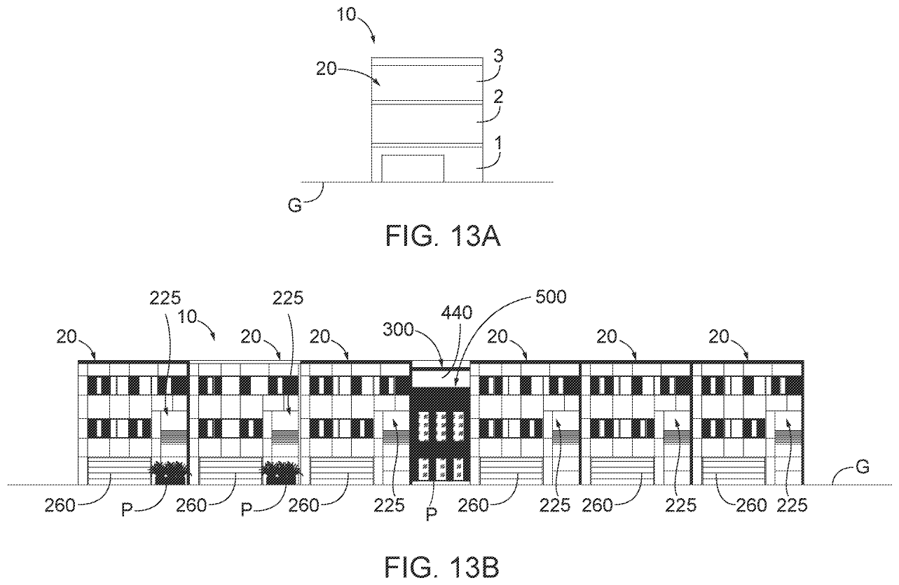

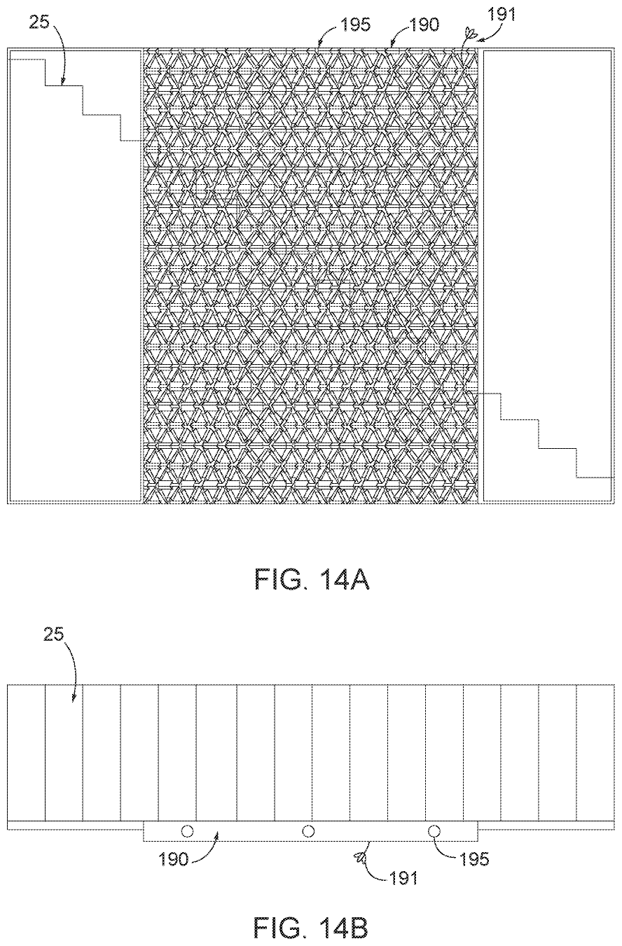

With reference to FIGS. 1, 13A and 13B, 21 and 23 the exterior cladding and appearance of residence 20 may vary to create different aesthetics. They are limited only by the creativity of the designer. The examples shown in the figures for the front, side and rear of the development are, therefore, not limiting. FIG. 13A shows an arrangement of level 1, level 2 and level 3 where the first level 1 is above ground G. It will be understood that other configurations may be used including a first level 1 below ground level G. With reference to FIG. 13B, a garage door 260 is provided on the rear of the residence 20 to access vehicle storage 30. This configuration is not limiting as the garage door 260 may be oriented based on constraints of the site to provide access on a different side of the residence 20 as needed. Alternatively, residence 20 may be oriented appropriately based on the site.

To further support wellness through the presence of plant material, living walls 500 may be incorporated within the development 10. In the example, shared space 300 includes a living wall 500 on the front and on the rear of the development 10. It will be understood that other portions of the development 10 including any of the various walls of the residences 20 may incorporate a living wall with plant material P. In the example, shown, living walls 500 are located on the front and rear of the shared space 300, described more completely below. In this example and others, the shared space 300 is located centrally relative to the residences in the development. Providing living walls 500 on the front and rear of the shared space 300 in such a central location makes it easier for each space to have a view of the living walls 500. The living wall 500 is more prominent in view from the outside and provides a visual break between the residential spaces. As noted above, the prominence and visibility of plant material P created by the living walls 500 enhances occupant well-being and has similar benefits for those passing by. Since it is likely that such a development will be located in an urban setting, the living walls provide welcome greenery in urban settings that are often devoid of plant life and surrounded by an abundance of hard surfaces, such as concrete, metal and glass construction.

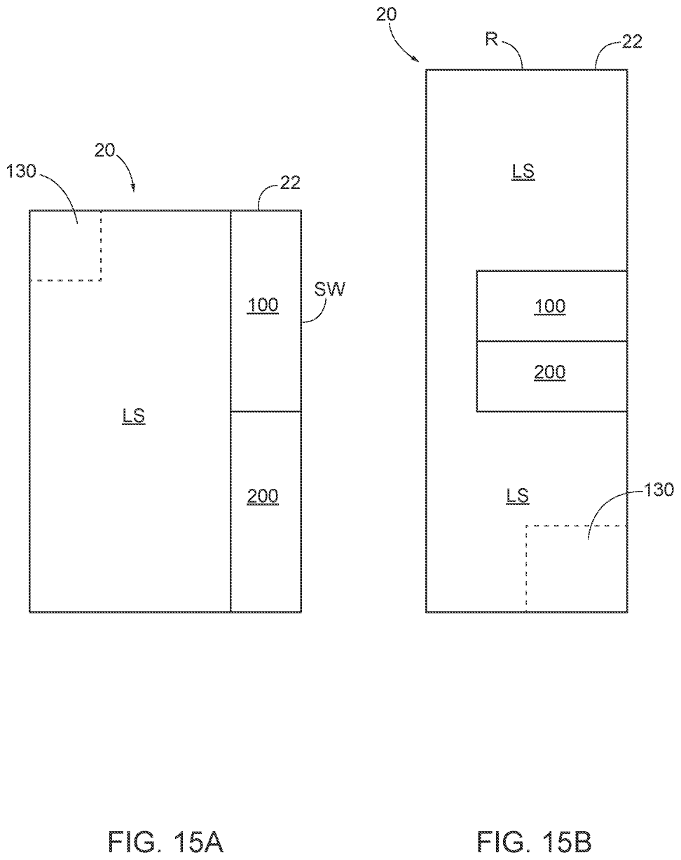

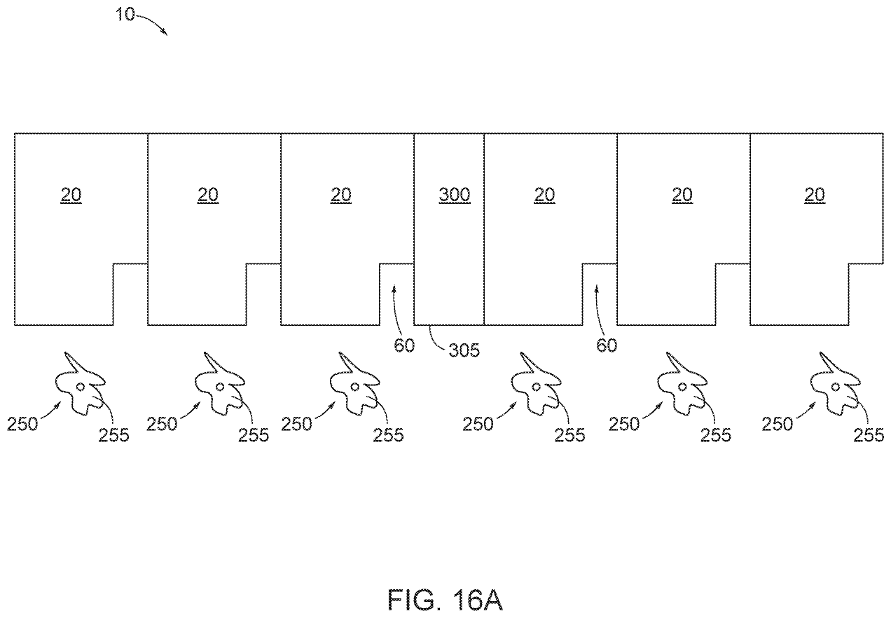

FIGS. 15A and 15B show alternative layouts of the mind-body space 100 relative to other spaces within the residence 20. In 15A, mind-body space 100 is located along a sidewall SW of a residence 20 along with creative space 200. In 15B, the mind-body space 100 is located centrally within the residence 20. In this example creative space 200 is placed back-to-back with mind-body space 100 bifurcating the residence 20. The remaining space shown may house any of the other spaces commonly found in a residence such as living spaces, bedroom spaces etc. In these figures, these living spaces are generally indicated with the letters LS. As schematically shown, in accordance with the principals described above, the location of the mind-body space at an outer wall 22 of residence 20 creates an opportunity to distance other spaces from the mind-body space 100. For example, a bedroom 130 may be located on the opposite wall relative to mind-body space in FIG. 15A. Likewise, having the mind-body space 100 in the center of residence as shown in FIG. 15B, provides an opportunity to distance spaces from it by placing them at the front F or rear R of residence 20. In the example, a bedroom 130 is shown at the front F of residence and is further separated from mind-body space 100 by the location of creative space 200 between it and mind-body space 100.

Development 10 may further include a shared space, generally indicated by the number 300. Shared space 300 may further enhance overall well-being for occupants by providing at least one of a fitness area, community garden, and co-working space. Such spaces have been shown to support a person's overall well-being and are recommended amenities within residential developments under the Well-Building Standard. The shared space 300 provides a community and social aspect to the development recognized as an important wellness component while maintaining a work from home environment that accommodates busy schedules. The wellness benefits of each will be discussed more completely in the examples below.

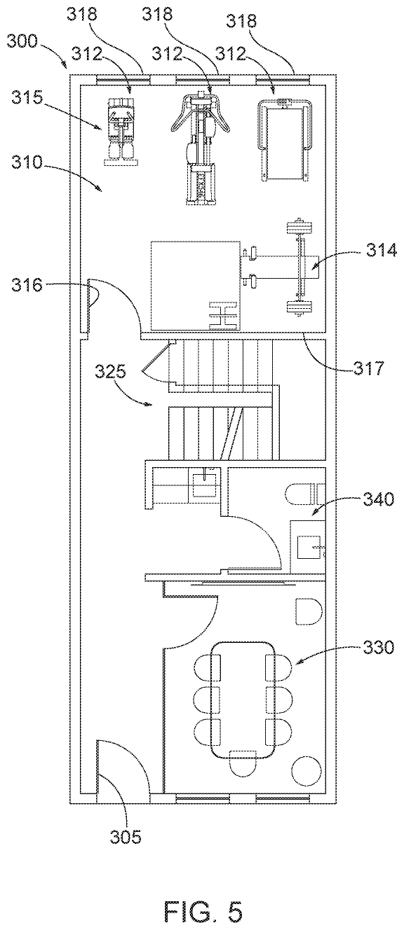

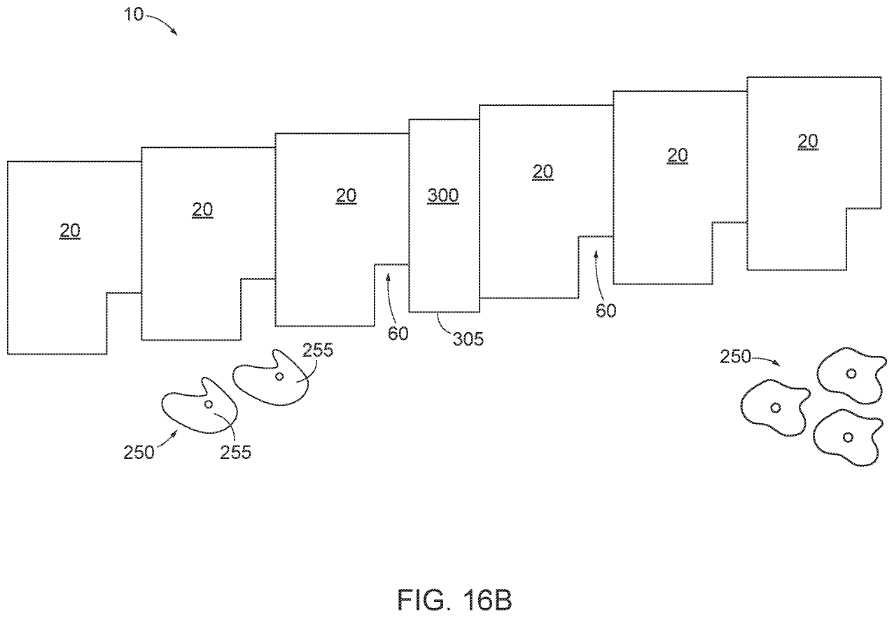

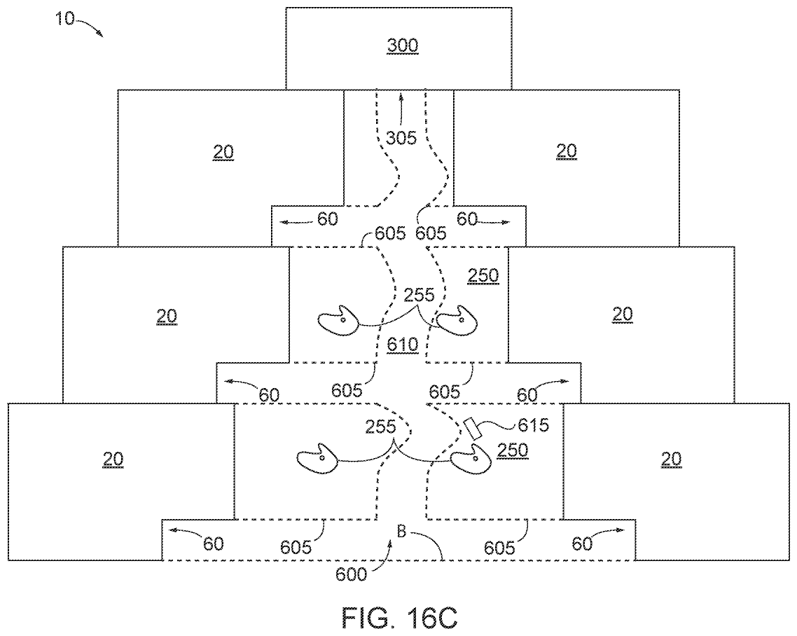

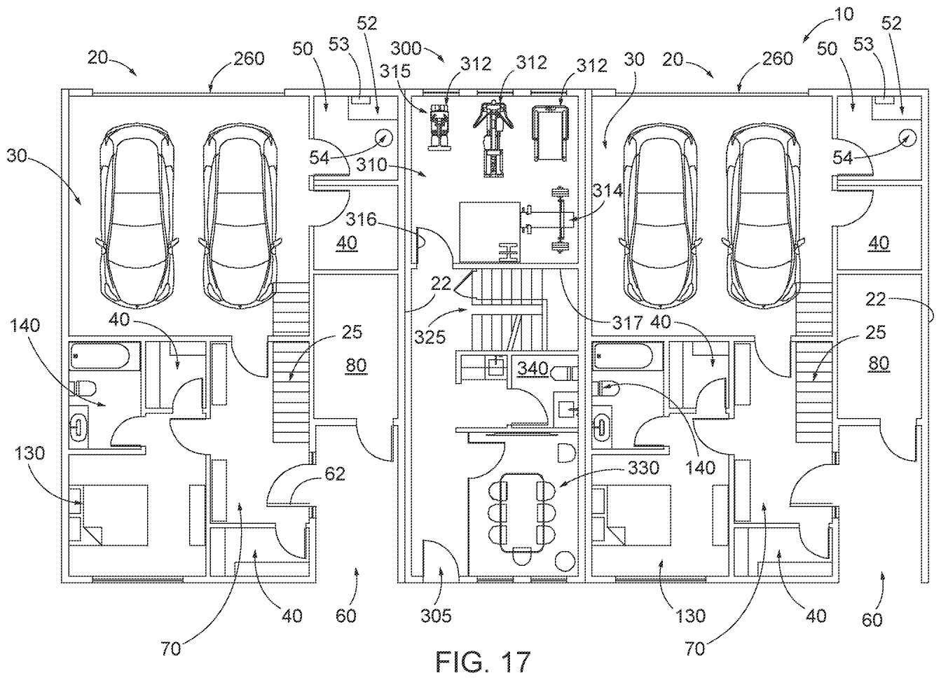

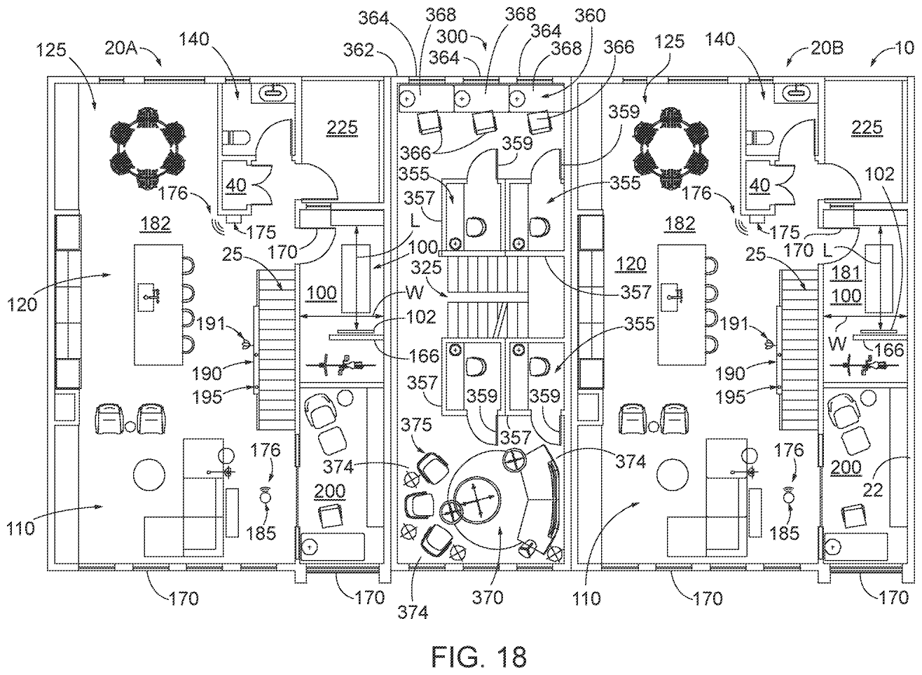

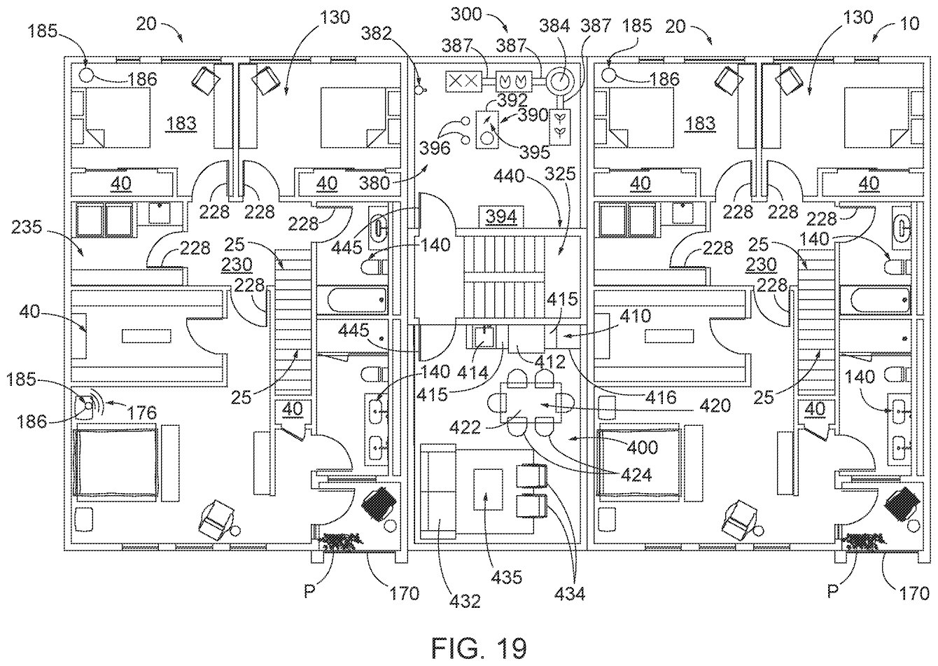

The configuration of shared space 300 may vary depending on the overall configuration of the development 10 as shown in FIGS. 1 and 16A-16C. In the example shown in FIGS. 5 and 25, shared space 300 has a rectangular shape with a long axis and a short axis. Shared space 300 may include one or more levels. The examples shown in the figures, which include two floors and a rooftop deck level, are not limiting.

First level may be a ground level and include an entry door 305 located at one end. In the example, first level has a generally rectangular footprint defined by outer wall 302. The sides 304 of outer wall 302 may be shared with adjacent residences as discussed more completely below, or shared space 300 may be constructed as a standalone unit within development 10. In the example, entry door 305 is located on the short axis of the rectangle defined by outer wall 302. Spaces within outer wall 302 may be arranged along the long axis of the space providing access to each of the spaces by traveling along a hallway 306 extending longitudinally from the entry door 305.

The first level may be divided into any number of spaces to be shared by the residences 20 including any of the example spaces described above. For example, the first level of shared space 300 includes a fitness area 310. Fitness area 310 may include fitness equipment 315 including but not limited to cardio equipment 312, such as a rowing machine, stationary bicycle and/or treadmill. Fitness equipment 315 may also include strength training equipment 314 including but not limited to weight-lifting equipment, resistance bands, TRX equipment, yoga mats, pilates trainers, and the like. These examples of fitness equipment 315 are not limiting as other types of fitness equipment may be used within this space.

Fitness area 310 may be located anywhere within first level. In the example shown, fitness area 310 is located at the opposite end of first level relative to the entry door 305. Since fitness areas often are loud due to the use of the fitness equipment itself or audio/visual equipment within the space, placing the fitness area 310 remotely from the entry door 305 minimizes its impact on those entering shared space 300. Fitness area 310 includes its own door 316 and is separated from the rest of first level by a wall 317. As shown, a stairwell 325 and rest room 340 may be placed adjacent to fitness space 310 to further assist in acoustically separating the fitness area 310 from other spaces within the first level. Stairwell 325 provides access to upper floors and facilitates movement activity within shared space. The stairs within stairwell 325 may be adapted to facilitate wheelchair movement between floors, or an elevator may be incorporated within shared space.

Fitness activity is important to wellness from both a physical activity standpoint, but also in the break that it provides from work or other daily activities. Since all occupants may engage in fitness activities within fitness area 310, windows 318 may be provided to allow views of nature while in the fitness area 310. As indicated above, viewing outdoor scenes, natural light and natural patterns all have a recognizable impact on reducing stress levels and calming one's mind and augment the wellness benefits of physical movement within the fitness area 310. The shared aspect of the fitness area provides a social component that also has been shown to enhance well-being.

First level may include a meeting space 330 adjacent to entry door. Meeting space 330 may be provided as part of a co-working environment discussed more completely below. With reference to FIG. 25 an alternative configuration of meeting space 330 is shown. In this configuration, plants P are incorporated within the meeting space 330 to foster the wellness principles of interacting with nature identified above, i.e., creating a biophilic zone. In addition, to make the meeting space 330 reconfigurable, tables 333 and chairs 334 that may be arranged separately for smaller groups or joined to form a larger seating/table area for larger groups are provided. The planters 331 shown are also intended to be mobile to facilitate rearrangement of meeting space 330. As shown, in addition to providing an interaction with plants P within the meeting space 330, planters 331 may be used to help divide the space and create intimate/cozy meeting areas as needed. The height of tables 333 may be adjustable in accordance with Well standards to provide further flexibility in the arrangement of the meeting space 330 and to allow the tables to accommodate users of different heights or use in seated or standing postures.

Meeting space 330 may be used as a central location for communications to residents including but not limited to the types of communications, programming, and community meetings identified as preconditions within the Well standard. In addition, meeting space 330 may be used for programming activities including but not limited to those identified in the Well standard.

Meeting space 330 is shown in the example at the front of the shared space 300 near the entry door. With reference to FIGS. 16A-16C, shared space 300 is integrated within the residential development 10 with residence(s) 20. In this way, residents within development 10 have direct access to shared space 300. The shared space 300 may be physically connected to one or more residence 20 as part of the integration. This further facilitates well-being by allowing a resident to walk a short distance to enter the shared space 300 without having to traverse a parking area or roadway. Placement of the shared space 300 may vary within the development 10. In the examples, shared space 300 is placed centrally within residences 20 to facilitate access, walkability and symmetry within the development 10. The shared space 300 and other common areas including green spaces and walkways may also include areas suited for particular programming or restorative activities. Indeed, the regular wellness programming contemplated by the Well standard may be conducted within the shared space 300 for purposes of obtaining certification of a built development 10.

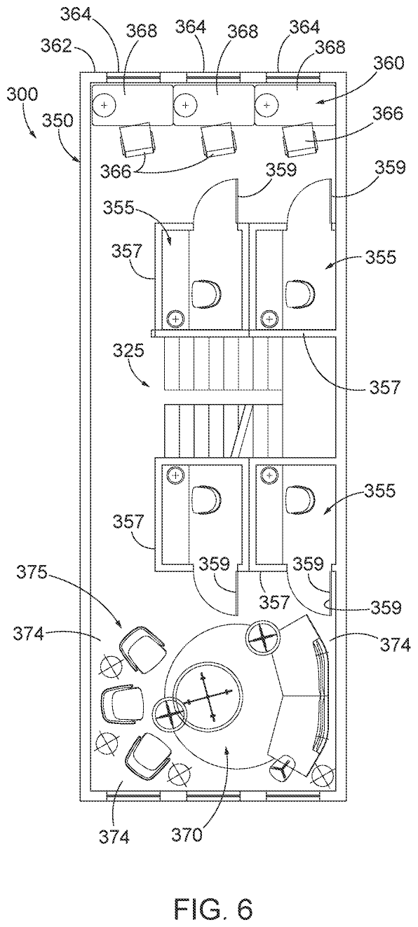

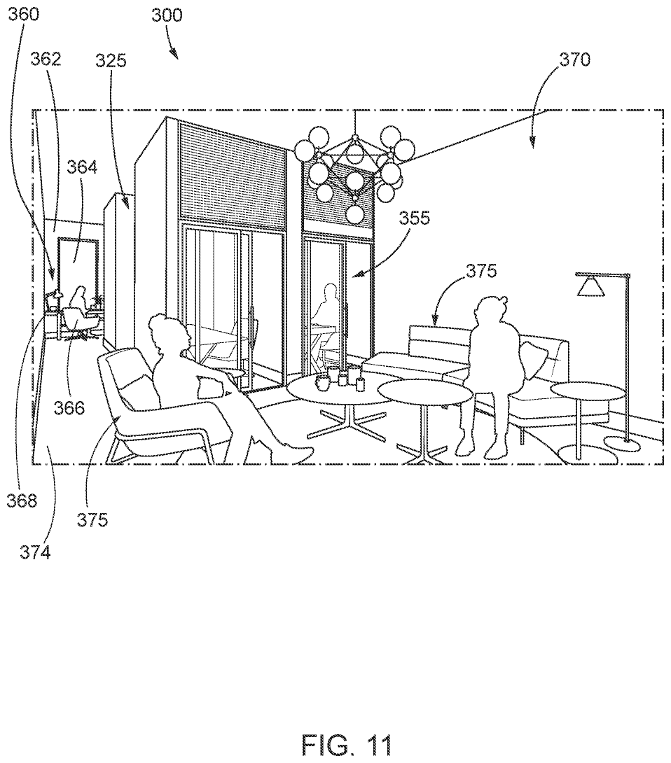

With reference to FIG. 6 and FIG. 11, shared space 300 may include a co-working space, generally indicated by the number 350. Co-working space 350 includes one or more privacy cabins 355. Privacy cabins 355 are enclosed spaces, each having its own door to reduce the likelihood that the sound generated during a call would disturb other occupants within the co-working space 350. In the example, privacy cabins 355 are located on either side of stairwell 325. Each conference call cabin 355 has its own outer wall 357 and door 359. Furniture including a desk, chair and lamp may be provided within each conference call cabin 355. It will be understood that the interior of each privacy cabin 350 may vary from the configuration shown. Built in benches may be used in place of chairs to increase seating or create an area where a user can recline or lie down. These spaces may be visually separated from meeting space 330 by a solid door or to allow natural light to enter the space, a door with a window or translucent/transparent door 359 may be used.

Co-working space 350 may also include open workstations 360. The open workstations 360 are located along a rear wall 362 of shared space 300 on second level. This placement maximizes the distance between workstations 360 and privacy cabins 355 to further help reduce any acoustic disturbance from calls. As shown, windows 364 may be in the rear wall 362 to provide natural light and allow workers to look outside while they are at workstations 360. In the example, workstations 360 have a direct line of site to natural light and nature adding an optimization to this room for Well certification purposes. Workstations 360 may be formed by a single table with multiple seats 366 or individual desks 368 may be placed adjacent to each other as shown.

The workstations 360 may be used by those that wish to communicate with each other. To that end, this space is located at the rear of shared space 300 on second level above fitness space 310. This vertically aligns two spaces where there may a higher incident of sound. The private office rooms 355 are centrally located away from the fitness area 310 and meeting space 330 on first level to minimize noise transmission from these spaces into the private office rooms 355 and vice versa.

A collaboration space 370 may be located at the front of shared space 300 on second level. This space 370 is a meeting space and is located above meeting space 330 such that the areas where there is likely to be more conversation correspond in a vertical sense. Collaboration space 370 is configured to facilitate creative thought and includes seating around the periphery 374 of space 370 to face all occupants toward each other. This placement facilitates face to face communication and an interplay between occupants. In addition, lounge furniture such as a couch, sofa or lounge chair are selected to place occupants more at ease to facilitate creative discourse. When not used for brainstorming sessions, lounge furniture 375 also provides a comfortable haven for breaks from work. Additional devices or tools commonly used for brainstorming discussion including a large screen or white board may be provided as part of this space 370.

Providing a co-working environment that is separate from the residence 20 allows a separation that reduces stress levels resulting from work interruption in a home setting or concern for non-work activities. Providing such a space attached to the residences 20 within a development 10 further reduces stress level by making it extremely accessible and if it is necessary to return home, the resident is only steps away.

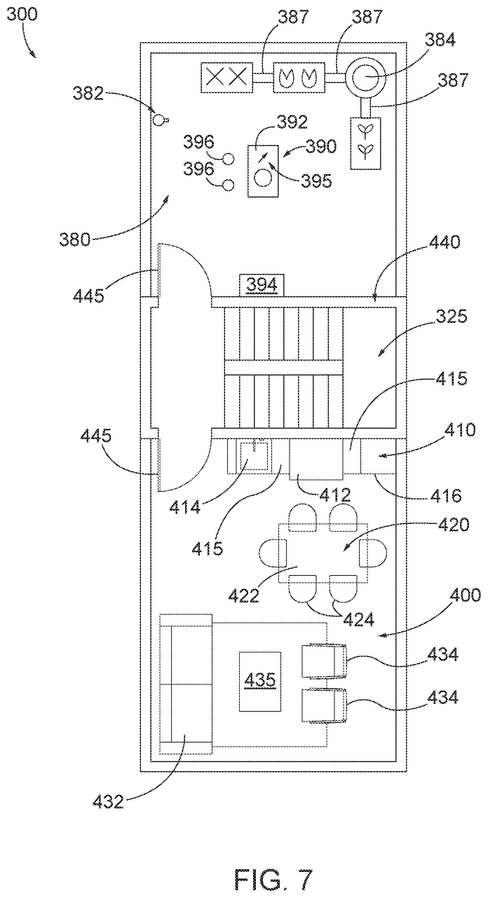

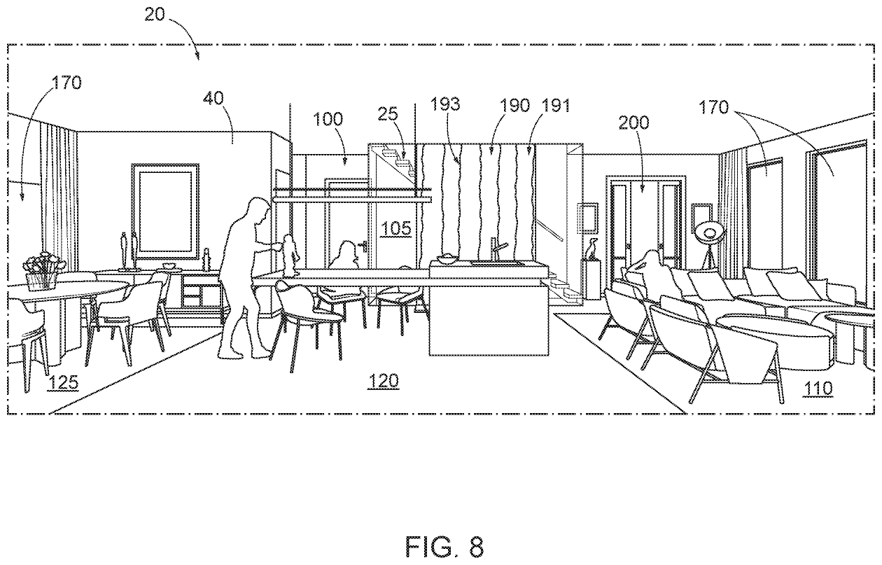

With reference to FIG. 7, a third level may be an outdoor area provided on shared space 300. This space may include one or more roof top terraces that are open to the outdoors. In the example, a pair of terraces are separated by a central stairwell 325. The terraces may be configured for the same function or different functions. In the example, the terraces include a community garden 380 and a roof top patio area 400.

Community gardening areas are indicated within the Well-building standard as an area that supports individual wellness. These areas provide community spaces that allow residents to work directly with nature and cultivate plant life. In the example, community garden 380 is located at the rear of shared space 300 on third level. Community garden 380 may include planters 385 or planting beds in which plants P are grown including but not limited to herbs, vegetables, fruit trees, flowers and the like. Water spigots 382 to supply water. Alternatively, rain barrels 384 may be used to collect water for use in the garden. Beds or planters 385 may be connected by piping 387 to form an irrigation system for plants. Community garden may include a work bench 390 providing a work surface 392 to facilitate gardening activities. Storage unit(s) 394 may house gardening equipment 395 when not in use. Community garden 380 may also include stools or other seating 396 for assisting in work areas or providing a place to relax and enjoy the setting.

Level three of shared space 300 may include an outdoor patio 400. Outdoor patio 400 provides an area for residents to congregate and relax. Outdoor patio 400 may include an outdoor kitchen 410, a dining area 420 and a lounge area 430 as shown. Outdoor kitchen 410 may be equipped with various cooking devices including for example a grill 412. It may also include a sink 414 and a portable refrigerator 416. These are arranged along the exterior wall of stairwell 325 along with work surfaces 415. Dining area 420 may include at least one table 422 and chairs 424. Lounge area may provide more comfortable seating, such as a sofa 432 and lounge chairs 434 situated around a coffee table 435.

In the example, outdoor patio 400 is located at the front of shared space 300 and is separated from community garden 380 by stairwell 325. The stairwell structure 440 physically separates the two spaces and each is provided with its own door 445. Separating the spaces in this way helps avoid noise from one space from disturbing residents in the other space. For example, the outdoor patio space 400 may be an area where there is considerable talking or music while the gardening space 380 may be quieter as residents work with plants. It will be appreciated that the location of these spaces may be reversed to take advantage of sun light at the appropriate time of day for the garden space.

With reference to FIGS. 16C, the shared space 300 and residences 20 may be connected by a walkway system 600 within the boundary B of the site. Walkways 600 may be provided to connect residences 20, shared space 300 and natural areas within greenspace 250 to encourage movement between the residences 20 and shared space 300 while allowing interaction with natural areas 255 within a greenspace 250. Providing the movement and interaction with nature inside the boundary B of the development 10 is an optimization within the Well standard. It will be understood that walkway system 600 may include one or more walkways in any configuration, limited only by the imagination of the designer within the context of the site. In the example, walkway system 600 includes residence walks 605 that extend from the entryway 60 of a residence 20. These connect to a central walkway 610 that meanders through the greenspace 250 and connects to shared space 300 at one end and the boundary B of development 10 at the other. The central walkway 610 moves through greenspace 250 in a meandering manner to extend the interaction with natural areas 255, and may include areas for reflection and restoration within greenspace 250. In one example, a bench 615 is accessible from walkway 610 and placed near a natural area 255.

Walkway system 600 may be made of any material including but not limited to cement, pavement, wood chips, gravel or combinations thereof. The paths may be at ground level or raised, such as a board walk, or include combinations of raised and ground sections to adapt the walkway system 600 to contours within the site or features such as waterways, wetland areas, or planted areas.

While various inventive aspects, concepts and features of the inventions may be described and illustrated herein as embodied in combination in the examples described herein, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Likewise, the words used in the claims have their full ordinary meaning and are not limited in any way by the description of the embodiments in the specification. Further, as described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

### EXAMPLES

Example 1. A residential development comprising: at least one residence, each residence includes a living space, a bedroom and a mind-body space; the mind-body space being configured for the practice of a wellness activity; and the mind-body space being separated from the bedroom.

Example 2. The residential development of example 1, wherein the development includes at least a first level and a second level, wherein the mind-body space and bedroom are located on separate levels from each other and are laterally displaced relative to each other.

Example 3. The residential development of example 1, wherein the residence includes a perimeter wherein the bedroom is located along the perimeter, and wherein the mind-body space is separated from the bedroom by being located centrally relative to the perimeter and spaced from the bedroom.

Example 4. The residential development of example 1 wherein the residence includes a rectangular perimeter including a front wall, a rear wall, a first sidewall and a second sidewall, wherein the mind-body space is located along the first sidewall, the residence including three bedrooms located on a level separate from the mind-body space, wherein a first bedroom is located along the front wall and the second sidewall; the second bedroom being located along the second sidewall and the rear wall; and the third bedroom being located adjacent to the second bedroom along the rear wall.

Example 5. The residential development of example 4, wherein the mind-body space is located along the first side wall and spaced from the rear wall and the front wall.

Example 6. The residential development of example 1, wherein the residence includes multiple levels, the mind-body space is separated from the bedroom by placing the mind-body space on a separate level from the bedroom, wherein at least one of a closet, a bathroom, a terrace and a storage space is aligned with the mind-body space and is located on the level with the bedroom.

Example 7. The residential development of example 1, wherein a terrace is located adjacent to one end of the mind-body space, and the mind-body space includes at least one window opening to the terrace.

Example 8. The residential development of example 1, wherein the mind-body space is separated from the bedroom by an air gap.

Example 9. The residential development of example 8, wherein the air gap is formed by a stair case.

Example 10. The residential development of example 1, further comprising an interior living wall facing opposite the mind-body space and spaced therefrom defining an air gap between the mind-body space and the living wall.

Example 11. The residential development of example 1, wherein the mind-body space is constructed with a higher insulation value relative to at least one of the living space and bedroom.

Example 12. The residential development of example 1, wherein the residence includes a home automation system that defines plural heating/cooling zones within the residence, wherein the mind-body space is defined as a separate zone having an independently adjustable temperature within the mind-body space.

Example 13. The residential development of example 1, wherein the residence includes a home automation system connected to at least the mind-body space, wherein the home automation system defines the mind-body space as a separate zone having at least one of an independently adjustable temperature, lighting and sound.

Example 14. The residential development of example 1 further comprising a creative space located adjacent to the mind-body space.

Example 15. The residential development of example 13, wherein the creative space and the mind-body space are located along a sidewall of the residence and at least one of the living space and the bedroom are located on an opposite sidewall.

Example 16. The residential development of example 13, wherein the mind-body space and the creative space are arranged back to back in a center of the residence and wherein at least one of the living space and the bedroom are located at a perimeter of the residence.

Example 17. The residential development of example 13, wherein the creative space is separated from the living space by an air gap, wherein a door to creative space is aligned with a portion of the living space and is transparent to allow viewing of an activity within the creative space from the living space.

Example 18. The residential development of example 1 further comprising an entryway external to the residence and having a door that opens into the residence, the residence further comprising an external storage space that is formed within a perimeter of the residence and has a door opening external to the residence within the entryway, wherein the external storage space is an elongated space configured to receive at least one outdoor sporting equipment.

Example 19. The residential development of example 1, further comprising a shared space having at least one of a co-working space and a community garden.

Example 20. The residential development of example 18, wherein the development includes at least two residences, wherein the shared space is connected to the at least two residences.

Example 21. The residential development of example 19, wherein the shared space is centered between the at least two residences.

Example 22. The residential development of example 20, wherein the shared space includes a front facade and a rear facade; wherein the front facade includes a living wall having plant material thereon.

Example 23. The residential development of example 21 wherein the rear façade includes a living wall having plant material thereon.

Example 24. The residential development of example 18, wherein the shared space includes a first floor, a second floor and a roof top terrace, wherein the roof top terrace is divided into a front portion and a rear portion by a central stairwell, wherein at least one of the front portion and the rear portion includes a community garden area.

Example 25. The residential development of claim 1, wherein the mind-body space further comprises at least one of a fitness mirror, a stationary bike, and a yoga mat.

Example 26. A residential development comprising: plural residences; each residence includes multiple levels, wherein a living space, a creative space and a mind-body space are located on one level and at least one bedroom is located on another level vertically separating the mind-body space and the creative space from the at least one bedroom, wherein the mind-body space and the creative space are laterally displaced relative to the at least one bedroom.

Example 27. A residential development comprising: plural residences connected to a shared space; each residence includes a first level and a second level above the first level; a mind-body space and a bedroom; the mind-body space being configured for the practice of a wellness activity; wherein the mind-body space is located on the first level and the bedroom is located on the second level; wherein the mind-body space and bedroom are laterally displaced relative to each other reducing the likelihood of acoustic transmission from the mind-body space into the bedroom; the shared space including at least one of a co-working space and a community garden.

Specific examples of an innovation are disclosed herein, but these examples are not limiting. One of ordinary skill in the art will readily recognize that the innovation may have other applications in other environments. In fact, many embodiments and implementations are possible. The following claims are in no way intended to limit the scope of the subject innovation to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the subject innovation has been shown and described with respect to a certain preferred embodiment or embodiments, equivalent alterations and modifications will occur to others skilled in the art upon the reading and understanding of this specification and the annexed drawings. In particular regard to the various functions performed by the above described elements (e.g., enclosures, sides, components, assemblies, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application. Although certain embodiments have been shown and described, it is understood that equivalents and modifications falling within the scope of the appended claims will occur to others who are skilled in the art upon the reading and understanding of this specification.

In addition, while a particular feature of the subject innovation may have been disclosed with respect to only one of several implementations, such feature may be combined with one or more other features of the other implementations as may be desired and advantageous for any given or particular application. As used herein, spatially orienting terms such as “above,” “below,” “upper,” “lower,” “inner,” “outer,” “right,” “left,” “vertical,” “horizontal,” “top,” “bottom,” “upward,” “downward,” “laterally,” “upstanding,” et cetera, can refer to respective positions of aspects as shown in or according to the orientation of the accompanying drawings. “Inward” is intended to be a direction generally toward the center of an object from a point remote to the object, and “outward” is intended to be a direction generally away from an internal point in the object toward a point remote to the object. Such terms are employed for purposes of clarity in describing the drawings, and should not be construed as exclusive, exhaustive, or otherwise limiting with regard to position, orientation, perspective, configuration, and so forth.

Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements. For an understanding of the scope of the invention, reference is made to the following claims.

1. A residential development comprising: at least one residence, each residence includes a living space, a bedroom and a mind-body space; the mind-body space being configured for the practice of a wellness activity; and the mind-body space being separated from the bedroom.

2. The residential development of claim 1, wherein the development includes at least a first level and a second level, wherein the mind-body space and bedroom are located on separate levels from each other and are laterally displaced relative to each other.

3. The residential development of claim 1 wherein the residence includes a rectangular perimeter including a front wall, a rear wall, a first sidewall and a second sidewall, wherein the mind-body space is located along the first sidewall, the residence including three bedrooms located on a level separate from the mind-body space, wherein a first bedroom is located along the front wall and the second sideman; the second bedroom being located along the second sidewall and the rear wall; and the third bedroom being located adjacent to the second bedroom along the rear wall.

4. The residential development of claim 1, wherein the mind-body space is separated from the bedroom by an air gap.

5. The residential development of claim 4, wherein the aft gap is formed by a stair case.

6. The residential development of claim 1, further comprising an interior living wall facing opposite the mind-body space and spaced therefrom defining an air gap between the mind-body space and the living wall.

7. The residential development of claim 1, wherein the mind-body space is constructed with a higher insulation value relative to at least one of the living space and bedroom.

8. The residential development of claim 1, wherein the mind-body space further comprises at least one of a fitness mirror, a stationary bike, and a yoga mat.

9. The residential development of claim 1, wherein the residence includes a home automation system connected to at least the mind-body space, wherein the home automation system defines the mind-body space as a separate zone having at least one of an independently adjustable temperature, lighting and sound.

10. The residential development of claim 1 further comprising a creative space located adjacent to the mind-body space.

11. The residential development of claim 10, wherein the creative space and the mind-body space are boated along a sidewall of the residence and at least one of the living space and the bedroom are located on an opposite sidewall.

12. The residential development of claim 10, wherein the mind-body space and the creative space are arranged back to back in a center of the residence and wherein at least one of the living space and the bedroom are boated at a perimeter of the residence.

13. The residential development of claim 10, wherein the creative space is separated from the living space by an air gap, wherein a door to creative space is aligned with a portion of the living space and is transparent to avow viewing of an activity within the creative space from the living space.

14. The residential development of claim 1 further comprising an entryway external to the residence and having a door that opens into the residence, the residence further comprising an external storage space that is formed within a perimeter of the residence and has a door opening external to the residence within the entryway, wherein the external storage space is an elongated space configured to receive at least one outdoor sporting equipment.

15. The residential development of claim 1, further comprising a shared space having at least one of a co-working space and a community garden.

16. The residential development of claim 15, wherein the development includes at least two residences, wherein the shared space is connected to the at least two residences.

17. The residential development of claim 15, wherein the shared space includes a front facade and a rear facade; wherein at least one of the front facade and rear façade includes a living wall having plant material thereon.

18. The residential development of claim 15, wherein the shared space includes a first floor, a second floor and a roof top terrace, wherein the roof top terrace is divided into a front portion and a rear portion by a central stairwell, wherein at least one of the front portion and the rear portion includes a community garden area.

19. A residential development comprising: plural residences; each residence includes multiple levels, wherein a living space, a creative space and a mind-body space are located on one level and at least one bedroom is located on another level vertically separating the mind-body space and the creative space from the at least one bedroom, wherein the mind-body space and the creative space are laterally displaced relative to the at least one bedroom.

20. A residential development comprising:
plural residences connected to a shared space;
each residence includes a first level and a second level above the first level; a mind-body space and a bedroom;
the mind-body space being configured for the practice of a wellness activity;
wherein the mind-body space is located on the first level and the bedroom is located on the second level; wherein the mind-body space and bedroom are laterally displaced relative to each other reducing the likelihood of acoustic transmission from the mind-body space into the bedroom;
the shared space including at least one of a co-working space and a community garden.
